(19) United States
(12) Patent Application Publication
(10) Pub. No.: US 2025/0324153 A1
(43) Pub. Date: Oct. 16, 2025

(54) WAVEFRONT DETECTION SYSTEM AND BUILDING METHOD OF OPTICAL PATH

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 19/174,877

(22) Filed: Apr. 9, 2025

(30) Foreign Application Priority Data
Apr. 12, 2024 (CN) 202410443335.4
Apr. 12, 2024 (CN) 202420759357.7

(51) Int. Cl. H04N 23/55; H04N 23/56; H04N 23/60

(52) U.S. Cl. CPC H04N 23/55; H04N 23/56; H04N 23/60

(57) ABSTRACT

A wavefront detection system and a building method of the optical path are provided The wavefront detection system includes: a target light source configured to emit a target laser at a target waveband; a grating, a 4f lens group and a camera along a propagation direction of the target laser in sequence; the 4f lens group includes a front lens and a rear lens along the propagation direction of the target laser in sequence; a rear focal plane of the front lens at the target waveband coincides with a front focal plane of the rear lens at the target waveband; an imaging sensor of the camera is configured to sense the target laser; the imaging sensor is set on a rear focal plane of the rear lens at the target waveband.

### CROSS-REFERENCE TO RELATED APPLICATIONS

This application claims the benefit of priority from Chinese Patent Applications No. 202410443335.4 and No. 202420759357.7, filed on Apr. 12, 2024. The entirety of each of the above-mentioned patent applications is hereby incorporated by reference herein and made a part of this specification.

### TECHNICAL FIELD

The present disclosure relates to the field of wavefront detection technology, in particular to a wavefront detection system and a building method of an optical path.

### BACKGROUND

In an optical field, to detect a phase distribution of the sample at a specific waveband, the detecting method for the specific sample usually includes: setting the optical gratings on the outgoing side of the sample lens, so that the lasers at a specific waveband generate interference while passing through the grating. And the imaging sensor is set on the outgoing side of the gratings, then according to the interference images collecting by the imaging sensor, the lasers at a specific waveband is performed with the wavefront detection, the phase distribution of the sample at the specific waveband is determined.

To detect the wavefront detection accurately, it is necessary to make the imaging sensor collect high-quality interference images to provide a wavefront detection system that can detect the wavefront of the sample smoothly, and the light path that meets the requirements of the wavefront detection system needs to be built accurately. However, the wavefront detection system provided by the related technology is more difficult to build.

### SUMMARY

In order to solve the problems in the prior art, the wavefront detection system and the building method of the optical path are provided according to the embodiments of the present disclosure. The wavefront detection system provided by the present application reduces the difficulty of building the optical path for the wavefront detection system.

According to an aspect of the present application, a wavefront detection system is provided. The wavefront detection system includes:
a target light source configured to emit a target laser at a target waveband; a grating, a 4f lens group and a camera in order along a propagation direction of the target laser in sequence;
the 4f lens group includes a front lens and a rear lens in order along the propagation direction of the target laser; a rear focal plane of the front lens at the target waveband coincides with a front focal plane of the rear lens at the target waveband;
an imaging sensor of the camera is configured to sense the target laser, and the imaging sensor is set on a rear focal plane of the rear lens at the target waveband;
the grating is set in front of the front focal plane of the front lens at the target waveband; and a sample to be detected is set between the target light source and the grating.

In one embodiment, the target light source is configured to emit a target laser at a far-infrared waveband; the rear focal plane of the front lens coincides with the front focal plane of the rear lens at the far-infrared waveband;
the imaging sensor is set on the rear focal plane of the rear lens at the far-infrared waveband; and the grating is set in front of the front focal plane of the front lens at the far-infrared waveband;
the sample to be detected works at the far-infrared waveband.

In one embodiment, the front lens and the rear lens are perpendicularly incident by the target laser at least, and the target laser at least passes through a center of the front lens and a center of the rear lens.

In one embodiment, a distance between the grating and a front focal plane of the front lens at the target waveband is positively correlated with a period of the grating; and the distance between the grating and a front focal plane of the front lens at the target waveband is inversely correlated with a numerical aperture of the sample to be detected.

In one embodiment, the period of the grating is 72 μm±3 μm;
when the numerical aperture of the sample to be detected is 0.04, a distance between the grating and a front plane of a front lens is 0.4 mm to 0.8 mm;
when the numerical aperture of the sample to be detected is 0.1, the distance between the grating and a front plane of a front lens is 0.3 mm to 0.45 mm;
when the numerical aperture of the sample to be detected is 0.15, the distance between the grating and a front plane of a front lens is 0.15 mm to 0.25 mm.

In one embodiment, the period of the grating is 144 μm±3 μm;
when the numerical aperture of the sample to be detected is 0.04, a distance between the grating and a front plane of a front lens is 0.3 mm to 1.8 mm;
when the numerical aperture of the sample to be detected is 0.1, the distance between the grating and a front plane of a front lens is 0.2 mm to 0.75 mm;
when the numerical aperture of the sample to be detected is 0.15, the distance between the grating and a front plane of a front lens is 0.2 mm to 0.45 mm.

In one embodiment, the period of the grating is 180 μm±3 μm;
when the numerical aperture of the sample to be detected is 0.04, a distance between the grating and a front plane of a front lens is 0.2 mm to 2.3 mm;
when the numerical aperture of the sample to be detected is 0.1, the distance between the grating and a front plane of a front lens is 0.2 mm to 0.9 mm;
when the numerical aperture of the sample to be detected is 0.15, the distance between the grating and a front plane of a front lens is 0.5 mm to 0.6 mm.

In one embodiment, a size of the sample to be detected is positively correlated with a value of f1/f2; f1 is a focal length of the front lens at the target waveband, and f2 is a focal length of the rear lens at the target waveband.

In one embodiment, a period of the grating is positively correlated with a value of f1/f2; f1 is a focal length of the front lens at the target waveband, and f2 is a focal length of the rear lens at the target waveband.

In one embodiment, a grating is a mesh 2D grating, and a phase difference between each unit block of the grating is n.

In one embodiment, a reflective lens group is set between the target light source and the grating, and the reflective lens group is configured to adjust the propagation direction of the target laser;
the reflective lens group further includes a reflective lens.

In one embodiment, a laser attenuator is set between the target light source and the grating, and the laser attenuator is configured to reduce a focal power of the target laser.

According to an aspect of the present application, an electronic device is provided. The electronic device includes:
setting a visible light source and a target light source, and setting the target laser and a visible laser emitted by the visible light source coaxially;
with the guidance of the visible laser, setting the grating, the 4f lens group and the camera on the optical path successively; the target laser is at least perpendicular to the front lens and the rear lens, and the target laser at least passes through the center of the front lens and the center of the rear lens;
controlling the imaging sensor locate at the rear focal plane of the rear lens at the target waveband, and controlling the rear focal plane of the front lens coincide with the front focal plane of the rear focal plane at the target waveband; and controlling the front focal plane of the front lens locate between the grating and the front lens, so as to build and obtain the optical path of the wavefront detection system.

In one embodiment, in the step of setting the target laser and a visible laser emitted by the visible light source coaxially, the step includes:
detecting a relative position between a spot of the target laser at a first spatial location and a spot of the visible laser at a second spatial location;
based on the detected relative position, adjusting the target laser and the visible laser to achieve coaxial alignment;
upon achieving coaxial alignment of the target laser and the visible laser, ensuring that the spots coincide at both the first and second spatial locations.

In one embodiment, the first spatial location that the visible laser passed through is located in front of the front lens; the second spatial location that the target laser passed through is located behind the rear lens; both the first spatial location and the second spatial location are located at a coaxial portion of the target laser and the visible laser;
with the guidance of the visible laser, setting the grating that is perpendicularly incident by the target laser, the 4f lens group and the camera includes:

adjusting an attitude of the front lens and an attitude of the rear lens based on a position deviation between a position of the visible laser reflected by the 4f lens group and the first spatial location, and based on a position deviation between the position of the visible laser from the 4f lens group and the second spatial location, so that the target laser is perpendicularly incident to the front lens and the rear lens and passes through the center of the front lens and the rear lens.

In one embodiment, the first spatial location that the visible laser passed through is located in front of the grating; and the second spatial location that the target laser passed through is located behind the grating; both the first spatial location and the second spatial location are located at a position of a coaxial portion between the target laser and the visible laser;

In the step of with the guidance of the visible laser, setting the grating, the 4f lens group and the camera on the optical path in sequence, the step includes:
adjusting an attitude of the front lens and an attitude of the rear lens, so that the target laser is perpendicularly incident to the front lens and the rear lens and the target laser passes through the center of the front lens and the center of the rear lens based on a position deviation between the visible laser reflected by the 4f lens group and the first spatial location;
adjusting the camera based on a position deviation between the visible laser reflected by the camera and the anterior spatial location, so that the target laser is perpendicularly incident to the camera.

In one embodiment, in the step of controlling the imaging sensor locate at the rear focal plane of the rear lens at the target waveband, the step includes:
setting the rear lens, and then setting the camera; next, setting the front lens;
when setting the camera, controlling the imaging sensor locate at the rear focal plane of the rear lens at the target waveband based on the spot that the imaging sensor sensed.

In one embodiment, the first spatial location that the visible laser passed through is located in front the front lens; the second spatial location that the visible laser passed through is located behind the camera;
both the first spatial location and the second spatial location are located at a coaxial portion between the target laser and the visible laser; the first spatial location and the second spatial location are configured to adjust the attitude of the 4f lens group;
after the step of controlling the imaging sensor locate behind the rear focal plane of the rear lens at the target waveband, the building method of the optical path further includes:
removing the camera from the optical path, and then setting the front lens based on the first spatial location and the second spatial location, and adjusting the attitude of the front lens at least;
moving the camera back to the optical path after setting the front lens.

In one embodiment, the visible laser passes through the first spatial location and the second spatial location;
in the step of controlling the rear focal plane of the front lens coincide with the front focal plane of the rear lens, the step includes:
obtaining a first target distance between the front lens and the rear lens, and a second target distance between the front lens and the rear lens, and obtaining a difference of the distance between the first target distance and the second target distance;
when a distance between the front lens and the rear lens keeps the first target distance, the rear focal plane of the front lens at the visible waveband coincides with the front focal plane of the rear lens at the visible waveband;
when the front lens and the rear lens keep the second target distance, the rear focal plane of the front lens at the visible waveband coincides with the front focal plane of the rear lens at the visible waveband;
based on the spot size of the visible laser at the first spatial location and the spot size of the visible laser at the second spatial location, adjusting a distance between the front lens and the rear lens to the first target distance; and then based on the difference of the distance, adjusting the first target between the front lens and the rear lens to the second target distance.

According to an aspect of the present application, a computer readable storage medium stores a computer readable instruction that causes the computer to execute any of the above embodiments of the method when the computer readable instruction is executed by a processor of the computer.

The wavefront detection system includes: a target light source configured to emit a target laser at a target waveband; a grating, a 4f lens group and a camera along a propagation direction of the target laser in sequence; the 4f lens group includes a front lens and a rear lens along the propagation direction of the target laser in sequence; a rear focal plane of the front lens at the target waveband coincides with a front focal plane of the rear lens at the target waveband; an imaging sensor of the camera is configured to sense the target laser, and the imaging sensor is set on a rear focal plane of the rear lens at the target waveband; the grating is set in front of the front focal plane of the front lens at the target waveband; and a sample to be detected is set between the target light source and the grating. In the wavefront detection system provided by the present application, the imaging sensor is set on the rear focal plane of the rear lens at the target waveband, and the grating is set in front of the front focal plane of the front lens at the target waveband. In this way, when building the optical path of the wavefront detection system, there is no need to sense the position of the imaging sensor, and there is no need for the device that can measure the fixed distance accurately, thus reducing the difficulty of the wavefront detection system of the optical path.

In order to make the above purposes, features and advantages of the disclosure more obvious and understandable, the embodiment is given below and illustrated in detail with the attached drawings.

It should be understood that the above general description and the following detailed description are exemplary only, and do not limit this application.

### BRIEF DESCRIPTION OF THE DRAWINGS

The present disclosure may be better understood by reference to the description given below in combination with the drawings, where the same or similar drawing markings are used in all the drawings to represent the same or similar assemblies. The drawings are included in the specification along with the following detailed description and form part of the specification, and to further illustrate the preferred embodiments of the disclosure and explain the principles and advantages of the disclosure.

FIG. 1 shows an architecture diagram of the wavefront detection system provided in the present application.

FIG. 2 shows a schematic diagram of the wavefront detection system provided by one embodiment of the present application.

FIG. 3 shows a schematic diagram of the phase detection system provided by the present application.

FIG. 4 shows a schematic diagram of the interference image collected by the imaging sensor when the sample hasn't been set on the optical path of the wavefront detection system provided by one embodiment of the present application.

FIG. 5 shows a schematic diagram of the interference image collected by the imaging sensor after setting the sample to the optical path based on the embodiment of FIG. 4.

FIG. 6 shows a schematic diagram of the theoretical phase distribution of the sample in the embodiment of FIG. 5.

FIG. 7 shows a schematic diagram of the phase distribution obtained after a restoration of the phase distribution of the sample from the interference image shown in the embodiment of FIG. 5.

FIG. 8 shows a schematic diagram of the interference image collected by the imaging sensor when the sample hasn't been set on the optical path of the wavefront detection system provided by one embodiment of the present application.

FIG. 9 shows a schematic diagram of the interference image collected by the imaging sensor after setting the sample on the optical path based on the embodiment of FIG. 8.

FIG. 10 shows a schematic diagram of the theoretical phase distribution of the sample in the embodiment of FIG. 9.

FIG. 11 shows a schematic diagram of the phase distribution obtained after a restoration of the sample by the interference image shown in the embodiment of FIG. 9.

FIG. 12 shows a flowchart of building the optical path for the wavefront detection system provided in the present application.

FIG. 13 shows a schematic diagram of building the optical path with the guidance of the by the present application.

FIG. 14 shows a schematic diagram of building the optical path with the guidance of the visible laser and by taking the first spatial location and the second spatial location as a reference in one embodiment.

FIG. 15 shows a schematic diagram of building the optical path with the guidance of the visible laser by adjusting the attitude of each element at the second spatial location as the reference in one embodiment of the present application.

FIG. 16 shows a schematic diagram of building the optical path with the guidance of the visible laser by adjusting the attitude of each element as a reference of the first spatial location and the second spatial location.

FIG. 17 shows a schematic diagram of building of the optical path with the guidance of the visible laser by controlling the distance between the front lens and the rear lens in one embodiment of the present application.

FIG. 18 shows a schematic diagram of building the optical path with the guidance of the visible laser by controlling the distance between the front lens and the rear lens in one embodiment of the present application.

FIG. 19 shows a schematic diagram of building the optical path with the guidance of the visible laser by adjusting the attitude as a reference.

FIG. 20 shows a schematic diagram of building the optical path with the guidance of the visible laser in one embodiment of this application.

FIG. 21 shows a schematic diagram of building the optical path after setting the camera in one embodiment of FIG. 20.

FIG. 22 shows a schematic diagram of building the optical path after removing the camera from the optical path in one embodiment of FIG. 21.

FIG. 23 shows a schematic diagram of building the optical path after setting the front lens in one embodiment of FIG. 22.

FIG. 24 shows a schematic diagram of building the optical path after adjusting the distance between the front lens and the rear lens to set the optical path after setting the 4f lens group in one embodiment of FIG. 23.

FIG. 25 shows a schematic diagram of building the optical path after moving the camera back to the optical path in the embodiment of FIG. 24.

FIG. 26 shows a schematic diagram of building the optical path after setting the grating in the embodiment of FIG. 25.

FIG. 27 shows a schematic diagram of building the optical path after adjusting the position of the grating in the embodiment of FIG. 26.

FIG. 28 shows a schematic diagram of building the optical path after setting the sample in the embodiment of FIG. 27.

FIG. 29 shows a schematic diagram of building the optical path with the guidance of the visible laser in one embodiment of this application.

FIG. 30 shows a block diagram of the building method of the optical path for the wavefront detection system provided in the present application.

### DETAILED DESCRIPTION OF THE EMBODIMENTS

The exemplary embodiment will now be described more comprehensively with reference to the accompanying drawings. However, the exemplary embodiments can be implemented in various forms and should not be understood to be limited to the examples elaborated herein; instead, providing these exemplary embodiments makes the description of this application more comprehensive and complete and fully communicates the idea of the exemplary embodiment to those skilled in the art. The attached drawings are only schematic illustrations of this application and are not necessarily proportional drawings. The same reference marks in the figure indicate the same or similar parts, and their repeated descriptions will be omitted.

Furthermore, the described features, structures or features may be combined in one or more exemplary embodiments in any suitable manner. In the following description, many specific details are provided to give a full understanding of the exemplary embodiments of this application. However, those skilled in the art will be aware that the technical solution of the present application may be practiced to omit one or more of the specific details described, or that other methods, groups, steps, and the like may be adopted. In other cases, aspects of the present application are blurred without detailed showing or describing the public structure, method, implementation or operation to avoid over-dominance.

Some of the box plots shown in the accompanying drawings are functional entities and do not necessarily have to correspond to physically or logically separate entities. These functional entities can be implemented in the form of software, or in one or more hardware modules or integrated circuits, or in different networks and/or processor devices and/or micro-controller devices.

In order to enable the imaging sensor to collect high quality interference images, sometimes it needs to keep a quite close distance between the grating and the imaging sensor L1. However, because the imaging sensor is usually set inside the camera, and in the camera there are lens elements with a certain volume (e.g. a lens group; a protective window glass), it is difficult to set the imaging sensor on a close enough location.

To overcome this problem, a 4f lens group can be chosen to set between the grating and the imaging sensor. Specifically, the 4f lens group includes a front lens and a rear lens (in the embodiment of this application, the relative concepts of “front” and “rear” are determined based on the optical path direction). Both the front lens and the rear lens are generally chose to be the focused lenses, and the rear focal plane of the front lens at the target waveband coincides with the front focal plane of the rear lens at the target waveband. In this way, for the laser at the target waveband, the frequency spectrum of the front focal plane of the front lens at the target waveband is same as the frequency spectrum of the rear focal plane of the rear lens at the target waveband. That is, for the laser at the target waveband, the 4f lens group can transfer the frequency spectrum of the front lens at the front focal plane at the target waveband to the rear focal plane of the rear lens at the target waveband.

The focal length of the front lens at the target waveband is f1, and the focal length of the rear lens is f2. The distance between the front focal plane of the front lens at the target waveband and the rear focal plane of the rear lens at the target waveband is 2*(f1+f2). Therefore, after setting the 4f lens group between the grating and the imaging sensor, to ensure “the grating is not located behind the front focal plane of the front lens at the target waveband” and “the imaging sensor is not located in front of the rear focal plane of the rear lens at the target waveband”, the imaging sensor will collect high-quality interference image by controlling the distance between the grating and the imaging sensor as L1+2*(f1+f2). Meanwhile, there is also no need to set the grating close enough to the imaging sensor.

For the wavefront detection system with a 4f lens group, the grating is usually located at the position of the front lens in the imaging sensor behind the rear focal plane of the rear lens at the corresponding waveband, and the distance between the imaging sensor and the rear lens at the corresponding waveband is controlled as L1.

In order to control the distance between the imaging sensor and the rear lens in the corresponding waveband to L1, it needs to be able to accurately perceive the position of the imaging sensor. However, since the imaging sensor is usually located at the camera, the position of the imaging sensor is not easily perceived in accuracy. Even if the position of the imaging sensor is accurately perceived, the relevant technology must accurately control the distance between the imaging sensor and the rear lens on the focal plane at the corresponding waveband as L1 by using the device that can measure the fixed distance between the two points accurately. It can be seen that the wavefront detection system with 4f lens group is more difficult to build the optical path of the wavefront detection system.

To overcome the above defects in the relevant technology, this application provides a wavefront detection system. The wavefront detection system provided in the present application reduces the difficulty of building the whole optical path of the wavefront detection system.

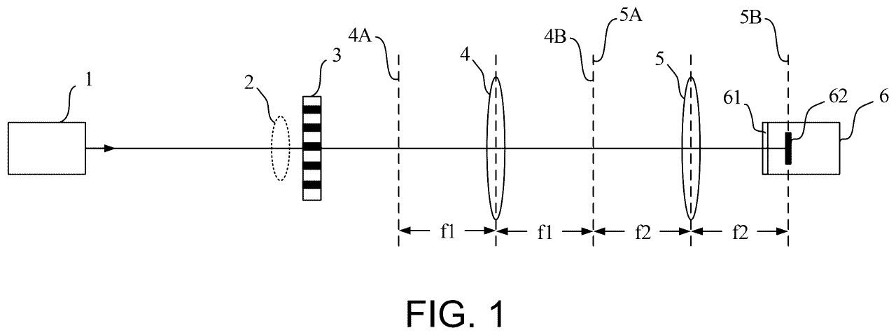

FIG. 1 shows a system architecture diagram of the wavefront detection system provided in the present application. Referring to FIG. 1, the wavefront detection system provided in this application is provided with a target light source 1, and the target light source 1 is used for emitting a target laser at the target waveband. In the direction of propagation of the target laser, the wavefront detection system is also provided with a grating 3, a 4f lens group, and a camera 6.

The 4f lens group along the propagation direction of the target laser in sequence includes a front lens 4 and a rear lens 5. The focal length of the front lens 4 at the target waveband is f1, and the front focal plane of the front lens 4 at the target waveband is 4A, and the rear focal plane of the front lens 4 is 4B. And the distance between the front lens 4 and the front focal plane 4A is f1, and the distance between the front lens 4 and the rear focal plane 4B is f1. The focal length of the rear lens 5 is f2. And the distance between the rear lens 5 and the front focal plane 5A is f2, and the distance between the rear lens 4 and the rear focal plane 5B is f2. The 4f lens group has a high transmittance for the target laser at the target waveband.

In the present application, the camera 6 is set behind the 4f lens group. The imaging sensor 62 is used to sense the target laser, that is, the imaging sensor 62 is configured to sense the light at the target waveband. And the imaging sensor 62 is set on the rear focal plane 5B of the rear lens 5.

It should be noted that when building the optical path, the rear lens 5 may be set firstly, and then the imaging sensor 62 may be set behind the rear focal plane 5B of the rear lens 5; next, the front lens 4 may be set.

During the process, it is neither necessary to sense the position of the imaging sensor 62 accurately nor to use a device that can measure the fixed distance between the two points accurately. In the present application, the grating 3 is set in front of the front plane 4A of the front lens 4, and the sample to be detected 2 is set between the target light source 1 and the grating 3. The sample to be detected 2 may be a traditional lens, or may be a diffraction optical element, or may be a metalens.

The distance between the grating 3 and the front focal plane 4A needs to keep a distance L1. It should be noted that when building the optical path, the position of the grating 3 may be set by sensing the sharpness of the edge of the grating 3. During the process, it is neither necessary to sense the position of the imaging sensor 62 accurately, nor to use a device that can measure the fixed distance between the two points accurately, the distance between the grating 3 and the imaging sensor 62 is controlled as L1+2*(f1+f2). In this way, the building difficulty of the optical path has been reduced.

It should be noted that there are two spatial locations on the optical axis of the 4f lens group, and the two spatial locations are recorded as the first spatial location and the second spatial location. When there is no sample to be detected 2 on the optical path, whether the rear focal plane of the front lens 4 and the rear lens 5 coincides with the light focal plane of the first spatial position and the second spatial location are determined.

It should be noted that when the rear focal plane of the control front lens 4 at the preset waveband coincides with the front focal plane of the rear lens 5 at the preset waveband, the selected preset waveband may be a target waveband or a non-target waveband. In this process, it is also neither necessary to sense the position of the imaging sensor 62 accurately, nor to use a device that can accurately measure the fixed distance between the two points.

In conclusion, the wavefront detection system provided in the present application sets the imaging sensor 62 on the rear focal plane 5B of the rear lens 5 at the target waveband, and sets the grating 3 in front of the front focal plane 4A of the front lens 4 at the target waveband. Therefore, when building the optical path of the wavefront detection system, the difficulty of building the optical path of the wavefront detection system has been reduced.

In the embodiment of the present application, the target waveband is located outside of the visible light waveband. In this embodiment, the target light source 1 emits a non-visible target laser at the waveband, and the non-visible target waveband includes but is not limited to: ultraviolet waveband, near-infrared waveband, and far-infrared waveband.

Specifically, when the target waveband is the far-infrared waveband, the grating 3, the front lens 4 and the rear lens 5 all have high transmittance at the far-infrared waveband; rear focal plane 4B of the front lens 4 in the far-infrared waveband coincides with the front focal plane 5A of the rear lens 5 in the far-infrared waveband; the imaging sensor 62 is mainly used to sense the beam of the far-infrared waveband; the imaging sensor 62 is provided in the rear focal plane of the rear lens 5 in the far-infrared waveband; the grating 3 is provided in the front focal plane of the front lens 4 in the far-infrared waveband; the sample 2 works at the far-infrared waveband. Similarly, the specific performance of the element adaptation in the non-visible light waveband will not be repeated.

In one embodiment, the grating 3 may be perpendicularly incident by the target laser.

In one embodiment, the grating 3 may be incident by the target laser with a preset angle.

In one embodiment, the front lens 4 and the rear lens 5 are at least perpendicularly incident by the target laser. And the target laser at least passes through a center of the front lens and a center of the rear lens, which enables the 4f lens group to transfer the frequency spectrum at the front focal plane 4A of the front lens 4 to the rear focal plane 5B of the rear lens 5 correctly.

In one embodiment, the imaging sensor 62 is perpendicularly incident by the target laser. Specifically, since the various lens elements arranged in the area preceding the imaging sensor 62 of the camera are generally parallel to the imaging sensor 62, the attitude of the imaging sensor 62 can be determined by observing the attitude of the lens element 61 set on the foremost of the camera 6 (for example, the foremost protective lens set in the camera 6) the most anterior lens element 61 in the observation camera 6. In this way, the target laser is incident to the imaging sensor 62.

In one embodiment, the distance L between the grating 3 and the front focal plane 4A of the front lens 4 at the target waveband is positively correlated with the period of the grating 3. And the distance L is inversely correlated with the numerical aperture of the sample 2.

Specifically, as mentioned above, to ensure that the imaging sensor 62 can collect high-quality interference images, it is necessary to control the close distance L between the grating 3 and the imaging sensor 62. After the introduction of the 4f lens group, when the control imaging sensor 62 is located at the rear focal plane 5B of the rear lens 5, it is necessary to control the grating 3 before the front focal plane 4A of the front lens 4, and control the distance L between the grating 3 and the front focal plane 4A of the front lens 4.

It should be noted that the distance L is positively correlated with the Talber distance of the grating 3, and the Talber distance of the grating 3 satisfies

$$Z = \frac{2 {d}^{2}}{λ} .$$

d is the period of the grating 3, and λ is a central wavelength of the working waveband. It can be seen that the distance L between the grating 3 and the front focal plane 4A is positively correlated with the period of the gating 3.

Moreover, with the increasing of the period of the grating 3, the distance between the center of first-order spectrum of the grating 3 and center of zero-order spectrum of the grating 3 will be getting smaller and smaller, thus reducing the spectrum filtering range of the grating 3.

Because the upper limit of the sample to be detected 2 is determined by the range of the frequency spectrum of the grating 3, the smaller the range of the frequency spectrum of the grating 3 is, the smaller the upper limit of the numerical aperture of the sample 2 tested by the grating 3 can be. Therefore, the distance L between the grating 3 and the front focal plane 4A of the front lens 4 is inversely correlated with the numerical aperture of sample 2.

In one embodiment, the period of the grating 3 is 72 μm±3 μm.

In the present application, when the numerical aperture of the sample to be detected 2 is 0.04, the distance L between the grating 3 and the front focal plane 4A of the front lens 4 is greater than or equal to 0.4 mm, and less than or equal to 0.8 mm.

When the numerical aperture of the sample to be detected 2 is 0.1, the distance L between the grating 3 and the front focal plane 4A of the front lens 4 is greater than or equal to 0.3 mm, and less than or equal to 0.45 mm.

When the numerical aperture of the sample to be detected 2 is 0.15, the distance L between the grating 3 and the front focal plane 4A of the front lens 4 is greater than or equal to 0.15 mm, and less than or equal to 0.25 mm.

In one embodiment, the period of the grating 3 is 144 μm±3 μm.

In the present embodiment, the numerical aperture to be detected is 0.04 of the sample 2, and the distance L between the grating 3 and the front focal plane 4A of the front lens 4 is greater than or equal to 0.3 mm, and less than or equal to 1.8 mm.

When the numerical aperture of the sample to be detected 2 is 0.1, the distance L between the grating 3 and the front focal plane 4A of the front lens 4 is greater than or equal to 0.2 mm, and less than or equal to 0.75 mm.

When the numerical aperture of the sample to be detected 2 is 0.15, the distance L between the grating 3 and the front focal plane 4A of the front lens 4 is greater than or equal to 0.2 mm, and less than or equal to 0.45 mm.

In one embodiment, the period of the grating is 180 μm±3 μm.

In the present embodiment, when the numerical aperture 2 of the sample to be detected 2 is 0.04, the distance L between the grating 3 and the front focal plane 4A of the front lens 4 is greater than or equal to 0.2 mm, and less than or equal to 2.3 mm.

When the numerical aperture 2 of the sample to be detected 2 is 0.1, the distance L between the grating 3 and the front focal plane 4A of the front lens 4 is greater than or equal to 0.2 mm, and less than or equal to 0.9 mm.

When the numerical aperture 2 of the sample to be detected 2 is 0.15, the distance L between the grating 3 and the front focal plane 4A of the front lens 4 is greater than or equal to 0.5 mm, and less than or equal to 0.6 mm.

In one embodiment, a size of the sample to be detected 2 is positively correlated with a value of f1/f2; f1 is a focal length of the front lens at the target waveband, and f2 is a focal length of the rear lens at the target waveband.

Specifically, if the beam diameter of the target laser before the modulation of the 4f lens group is unchanged, the larger the value of f1/f2 is, the smaller the beam diameter of the target laser after the modulation of the 4f lens group is. That is, when the target laser doesn't change, the value of f1/f2 increases, the target laser modulated by the 4f lens may be performed with shrinkage. Similarly, if the beam diameter of the target laser is unchanged before modulation, the smaller the value of f1/f2 is. That is, when the target laser is unchanged, the target laser modulated by the 4f lens can be expanded by reducing the value of f1/f2.

In the present embodiment, when the size of sample to be detected 2 is quite small, the target laser modulated by the 4f lens can be shrunk by increasing the value of the value of f1/f2, thus reducing the size of image. In this way, the detection range for the sample to be detected 2 can be expanded.

In one embodiment, a period of the grating 3 is positively correlated with a value of f1/f2; f1 is a focal length of the front lens 4 at the target waveband, and f2 is a focal length of the rear lens 5 at the target waveband.

Specifically, adjusting the value of f1/f2 for shrinkage or expansion will result to a change in the accuracy of the phase distribution obtained by the restoration of the interference image. If the restoration accuracy of the phase distribution needs to keep unchanged, the period of the grating 3 can be adjusted almost simultaneously.

Therefore, in the present embodiment, after adjusting the value of f1/f2, the period of the grating 3 is also adjusted accordingly. Specifically, if the value of f1/f2 is increased, the period of the grating 3 is also increased; if the value of f1/f2 is reduced, the period of the grating 3 is also reduced, thus keeping the restoration accuracy of the phase distribution basically unchanged.

In one embodiment, the grating is a mesh 2D grating, and a phase difference between each unit block of the grating is π. Therefore, the target laser passing through sample to be detected 2 has four-wave of shear interference when passing through grating 3.

It should be noted that since four-wave shear interference can occur in either coherent or irrelevant light, the present embodiment reduces the coherence requirement of the target laser by performing wavefront detection based on four-wave shear interference.

In one embodiment, a reflective lens group is set between the target light source 1 and the grating 3, and the reflective lens group is configured to adjust the target laser in the propagation direction; the reflective lens group at least includes a reflective lens.

Specifically, sometimes both the volume and the weight of the target light source 1 are rather large. In this situation, it is difficult to adjust the attitude of the target light source 1 directly. Therefore, in order to adjust the propagation direction of the target laser without adjusting the position of the target light source 1, in the present embodiment, a reflective lens group is set between the target light source 1 and the grating 3, and the reflective lens group at least includes a reflective lens. In this way, when the propagation direction needs to be adjusted, only the attitude of one reflective lens in the lens group needs to be adjusted.

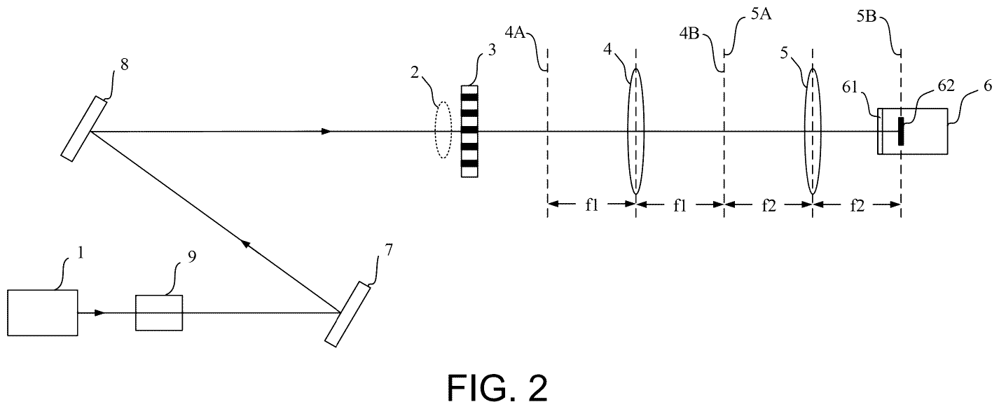

FIG. 2 shows a schematic diagram of the wavefront detection system provided by one embodiment of the present application. As shown in FIG. 2, in one embodiment, a first reflective lens 7 and a second reflective lens 8 are set between the target light source 1 and the grating 3. And the reflective lens group are composed of the first reflective lens 7 and the second reflective lens 8.

In the present embodiment, the target light source 1 can be set horizontally. When building the optical path for the wavefront detection system, the target laser is allowed to continue propagating horizontally at different heights by adjusting the angle of at least one of the first reflective lens 7 and the second reflective lens 8.

As shown in FIG. 2, in one embodiment, a 1 setting a visible light source is set between the target light source and the grating, and the laser attenuator is configured to reduce the focal power of the target laser. The laser attenuator 9 is provided because if the optical power of the target laser is larger, the imaging sensor 62 will be damaged after the target laser is incident to the imaging sensor 62. Therefore, in this embodiment, a laser attenuator 9 is set between the target light source 1 and the grating 3 to reduce the optical power of the target laser and to avoid the damage to the imaging sensor 62.

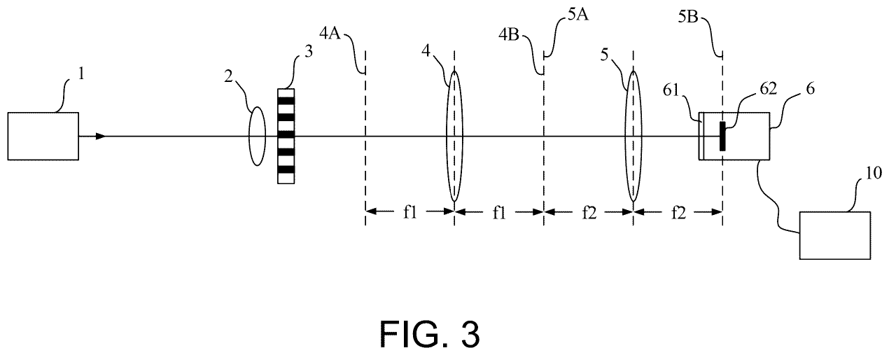

A phase detection system is provided by the present application. FIG. 3 shows a schematic diagram of the phase detection system provided by the present application. As shown in FIG. 3, the phase detection system includes the wavefront detection system; a sample 2, and the target laser is incident to the sample 2, and the target laser passes through a center of the sample 2; a processor 10.

The sample to be detected 2 is set between the target light source 1 and the grating 3, and the target laser is perpendicularly incident to the sample to be detected 2 and passes through the center of the sample to be detected 2. Therefore, the target laser 2 passed through the sample 2 will generate interference. Under the transfer of the spectrum for the 4f lens group, the imaging sensor 62 senses the target laser to acquire a high-quality interference image.

The processor 10 is electrically connected to the camera 6, and the processor 10 is configured to receive an interference image that the target laser sensed by the imaging sensor 62, so as to detect a phase distribution of the sample based on the interference image.

It should be noted that the specific processing method of the processor 10 to restore the phase distribution mainly depends on the specific type of interference of the target laser when passing through the grating 3. Therefore, as long as the grating 3 is determined, the specific type of interference can be determined, and the restoration of the processor 10 can be performed on the phase distribution by using a matched process. For example, when the grating 3 is a mesh 2D grating, and a phase difference between each unit block of the grating is π. When the target laser passes through the grating 3, the processor 10 can restore the phase distribution of the sample to be detected 2 from the interference image by using an algorithm matching the four-wave shear interference

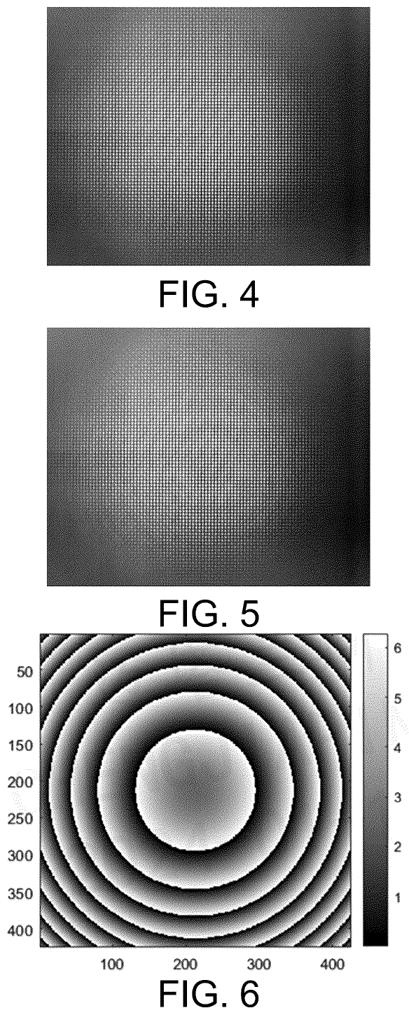

FIG. 4 shows a schematic diagram of the interference image obtained by the imaging sensor when the sample to be detected 2 is not added to the optical path of the wavefront detection system provided by one embodiment of the present application. FIG. 5 shows a schematic diagram of the interference image of the imaging sensor after adding the sample to be detected 2 to the optical path based on the embodiment of FIG. 4. FIG. 6 shows a schematic diagram of the theoretical phase distribution of the sample in the embodiment of FIG. 5. FIG. 7 shows a schematic diagram of the phase distribution obtained after the restoration of the sample to be detected 2 by the interference image shown in the embodiment of FIG. 5.

Referring to FIGS. 4 to 7, in one embodiment, a far-infrared laser emitted by the target light source has a central wavelength of 10.6 μm. The period of the mesh 2D grating is 72 μm. Both the front and back lenses are zinc selenide lenses with a focal length of 25.4 mm in the far-infrared waveband; the grating is set in front of the front focal plane at the far-infrared waveband, and the distance between the grating and the front focal plane in the far-infrared waveband is 0.6 mm; the working waveband of the camera is 8 to 12 μm. The diameter of the spot sensed by the camera is 6 mm. Because the focal length of the front lens and the rear lens are consistent. This indicates that the diameter of the spot projected on the sample to be detected 2 is about 6 mm; the sample to be detected 2 is a zinc selenide lens with a focal length of 75 mm at the far-infrared waveband. Combined with the diameter of the spot on the sample to be detected 2 of 6 mm, the actual numerical aperture of the diameter of the sample to be detected 2 is 0.04.

In the present embodiment, after building the optical path of the wavefront detection system, when the sample to be detected 2 is not added to the optical path, the imaging sensor of the camera will collect the interference image shown in FIG. 4. After adding the sample to be detected 2 to the optical path, the imaging sensor will obtain the interference image as shown in FIG. 5.

The processor processes the interference image shown in FIG. 5 according to the principle of four-wave shear interference, thus restoring the phase distribution shown in FIG. 7. Comparing FIG. 6 and FIG. 7, in this embodiment, the phase distribution obtained by sample restoration is very close to the theoretical phase distribution, thus indicating that the phase detection accuracy in this embodiment is very high, and then the position and attitude of each element in the wavefront detection system provided in this embodiment are accurate.

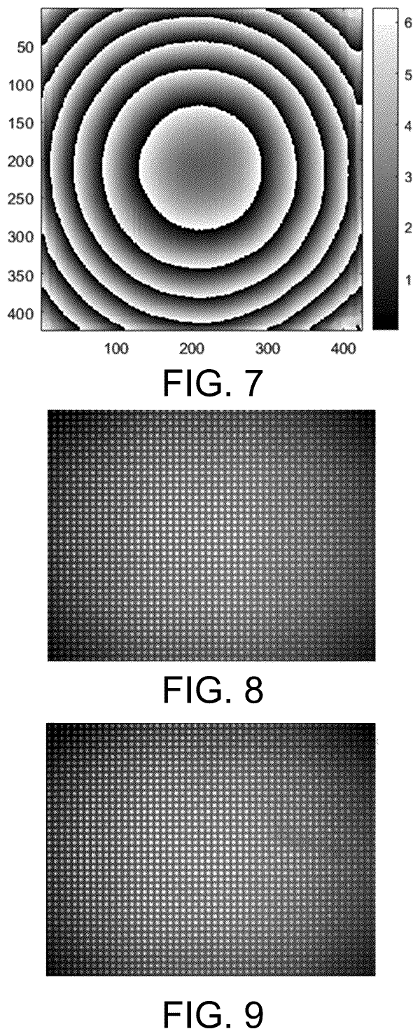

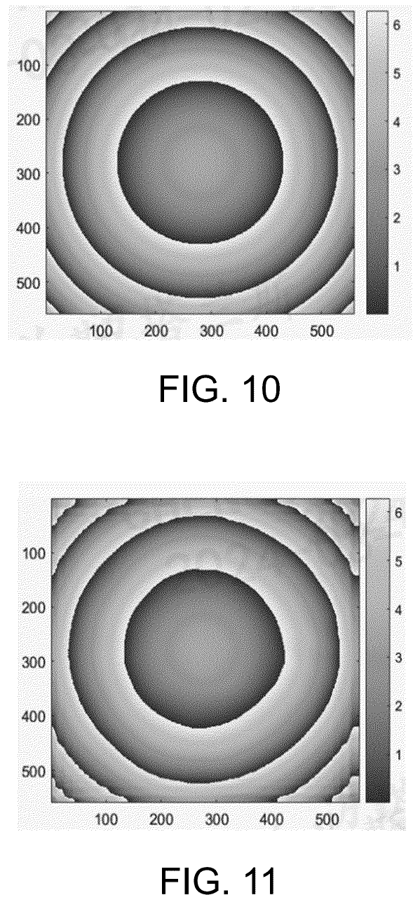

FIG. 8 shows a schematic diagram of the interference image obtained by the imaging sensor when the sample is not added to the optical path of the wavefront detection system provided by one embodiment of the present application. FIG. 9 shows a schematic diagram of the interference image obtained by the imaging sensor after further adding the sample into the optical path based on the embodiment of FIG. 8. FIG. 10 shows a schematic diagram of the theoretical phase distribution of the sample in the embodiment of FIG. 9. FIG. 11 shows a schematic diagram of the phase distribution after a restoration of the sample by the interference image shown in the embodiment of FIG. 9.

Referring to FIGS. 8 to 11, in one embodiment, the target light source emits a far-infrared laser light with a central wavelength of 10.6 μm. The grating is a 2D mesh grating with a period of 72 μm. The front lens is a zinc selenide lens with focal length of 25.4 mm in the far-infrared waveband, and the rear lens is a zinc selenide lens with focal length of 50.8 mm at the far-infrared waveband. The grating is provided before the front focal plane of the front lens in the far-infrared waveband, and the distance between the grating and the front lens in the far-infrared waveband is 0.7 mm; the working waveband of the camera is 8 to 12 μm; the diameter of the spot sensing by the camera is about 6 mm; because the focal length of the front lens is half the focal length of the rear lens, the diameter of the spot projected on the sample to be detected 2 is about 3 mm. The sample is a zinc selenide lens with the focal length of 50.8 mm at the far-infrared waveband. Combined with the diameter of the spot on the sample to be detected 2, the actual numerical aperture diameter of the sample to be detected 2 is 0.03.

In the present embodiment, after building the optical path of the wavefront detection system and before adding the sample to be detected 2 to the optical path, the imaging sensor of the camera will obtain the interference image as shown in FIG. 8. After adding the sample to the optical path, the imaging sensor will obtain the interference image as shown in FIG. 9.

It should be noted that in this embodiment, the focal length of the rear lens is 2 times of the focal length of the front lens, so that the far-infrared laser adjusted by the 4f lens group can expand the beam; the expanding beam can be reflected by the restoration of the spot density. Specifically, the spot density of the interference image shown in FIG. 8 and FIG. 9 is by half compared to the spot density of the interference image shown in FIG. 4 and FIG. 5.

It should be noted that in order to enable the 4f lens group to correctly transfer the spectrum of the front lens at the front focal plane at the target waveband to the rear focal plane of the rear lens at the target waveband, the laser vertically incident that controls the front lens and the rear lens of the target waveband and passes through the center of the front lens and the center of the rear lens. However, because the laser of the non-visible waveband can't be observed by eyes, it is difficult to observe the deviation of the related position between the laser, the front lens and the rear lens at the non-visible waveband. The deviation of the relative attitude between the laser, the front lens and the rear lens can be corrected. Therefore, it's difficult to build the optical path satisfied the requirements of the wavefront detection system for the non-visible laser, so that the non-visible laser will be perpendicularly incident to the centers of the front lens and the rear lens.

Therefore, the building method of the optical path for the wavefront detection system in the present application. According to the building method of the optical path provided in the present application, the optical path enables the optical path of the waveband through the center of the front lens and the center of the rear lens so that the imaging sensor can collect a high quality interference image, thus enabling the interference image to accurately wavefront detection of the laser of the non-visible waveband passing through the sample to be detected 2.

Referring to FIG. 1, in the embodiment of this application, the target waveband is located outside the visible waveband, that is, the target waveband is a non-visible waveband. In the present embodiment, a sample to be detected is set between the target light source 1 and the grating 3. In this way, after setting the sample to be detected 2 between the target light source 1 and the grating 3, there will be interference as the target laser that has passed through the sample to be detected 2 passing through the grating 3. Therefore, when sensing the target laser that passed through the grating 3, the interference image containing the phase information can be collected used for the wavefront detection.

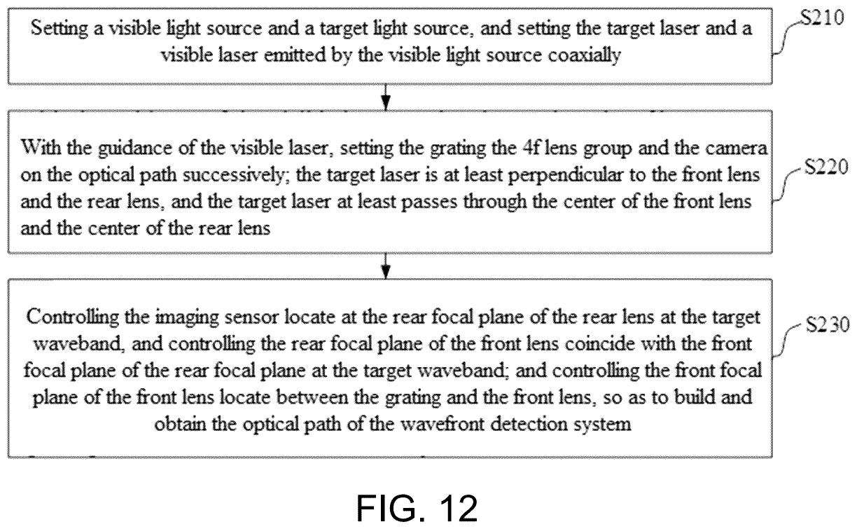

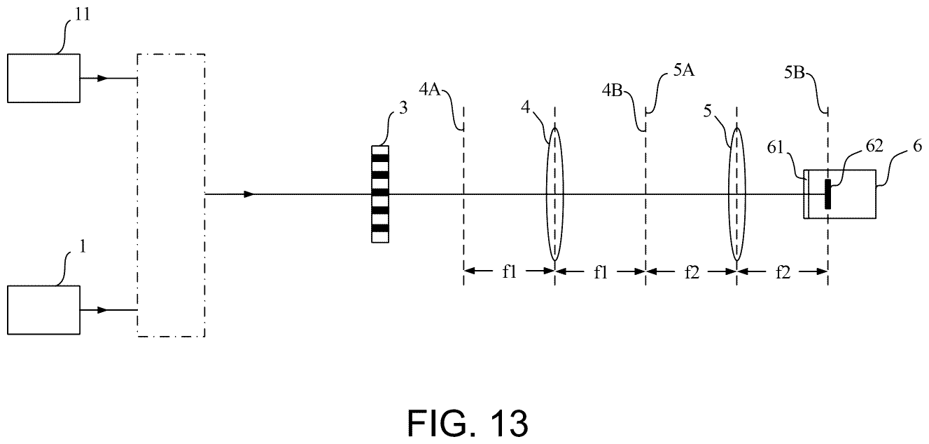

FIG. 12 shows a flowchart of building method of the optical path for the wavefront detection system provided in the present application. FIG. 13 shows a schematic diagram of the building method of the optical path when the visible laser is guided by the present application. Referring to FIG. 12 and FIG. 13, the methods provided in this application includes:

Step 210.setting a visible light source and a target light source, and setting the target laser and a visible laser emitted by the visible light source coaxially;

Step 220. with the guidance of the visible laser, setting the grating, the 4f lens group and the camera on the optical path successively; the target laser is at least perpendicular to the front lens and the rear lens, and the target laser at least passes through the center of the front lens and the center of the rear lens;

Step 230. controlling the imaging sensor locate at the rear focal plane of the rear lens at the target waveband, controlling the rear focal plane of the front lens coincide with the front focal plane of the rear focal plane at the target waveband; and controlling the front focal plane of the front lens locate between the grating and the front lens, so as to build and obtain the optical path of the wavefront detection system.

Specifically, in the present embodiment, when building the optical path, the visible target light source 11 and the target light source 1. The visible laser emitted by the visible light source 11 can be observed by eyes. And when setting the visible light source 11 and the target light source 1, the visible light source 11 and the target light source 1 are set coaxially. That is, the target laser and the visible laser are set coaxially within a certain spatial range. At the position of the coaxial portion between the target laser and the visible laser, the target laser coincides with the visible laser.

It can be seen that as long as the visible laser at the position of the axial portion between the visible laser and the target laser can be incident to the grating 3, the 4f lens group and the camera 6 in sequence, and the visible laser can be perpendicular to the front lens 4 and the rear lens 5 at least, and the visible laser will pass through the center of the front lens 4 and the center of the rear lens 5, at the axial portion between the visible laser and the target laser, the target laser will pass through the grating 3, 4f lens group and the camera 6 in sequence, and the target laser is also incident to the grating 3, the 4f lens group and the camera 6 in sequence, and at least perpendicularly incident to the front lens 4 and the rear lens 5, and the target laser passes through the center of the front lens 4 and the center of the rear lens 5 at least.

Because the visible laser can be observed by eyes, with the guidance of the visible laser, the deviation of the relative attitude between the laser, the front lens 4 and the rear lens 5 will be sensed easily. It is easy to correct the relative attitude between the laser, the front lens 4 and the rear lens 5, thus satisfying the target requirements of the relative attitude.

At the same time, the imaging sensor 62 is located at the rear focal plane 5B of the rear lens 5, and the rear focal plane 4B of the front lens 4 coincides with the front focal plane 5A of the rear lens 5. The front focal plane 4A of the front lens 4 is controlled locate between the grating 3 and the front lens 4 (that is, controlling the grating 3 locate in front of the front focal plane 4A of the front lens 4) to build the optical path of the wavefront detection.

In conclusion, when building the optical path by using the building method provided by the present application, the difficulty of correcting the deviation of the relative attitude between the laser, the front lens 4 and the rear lens 5 has been reduced by using the visible laser to guide the target laser at the non-visible waveband.

It should be noted that in the present application, the element used when building the optical path is not a necessarily part of a wavefront detection system. For example, according to the building method of the optical path provided by the present application, although the visible light source 11 may be used, it doesn't represent the visible light source 11 belongs to the wavefront detection system. It should be understood that after building the optical path, the visible light source 11 can be removed when the wavefront detection system is used formally.

It is also noted that as described above, after the 4f lens group being set between the grating 3 and the imaging sensor 62, it is ensured that “the grating 3 is not behind the front focal plane 4A of the front lens 4 at the target waveband” and “the imaging sensor 62 is not at the front of the rear focal plane 5B of the rear lens 5 at the target waveband”, for the distance between the grating 3 and the imaging sensor 62, only the distance between the grating 3 and the imaging sensor 62 needs to be controlled as L1+2*(f1+f2). For the wavefront detection system with a 4f lens group, the grating 3 is usually set at the position of the front focal plane 4A at the target waveband, the imaging sensor 62 is set behind the rear focal plane 5B of the rear lens 5 at the target waveband and the distance between the imaging sensor 62 and the rear focal plane 5B of the rear lens 5 at the target waveband is controlled to be L1.

The embodiment of the present application sets the imaging sensor 62 at the rear focal plane 5B of the rear lens 5 at the target waveband and the embodiment sets the grating 3 in front of the front focal plane 4A of the front lens 4 at the target waveband.

In one embodiment, the wavefront detection system requires the target laser being perpendicularly incident to the grating 3. Therefore, when setting the grating 3, the attitude of the grating 3 is adjusted, so that the visible laser is perpendicular to the grating 3. In this way, the target laser is perpendicular to the grating 3 with the guidance of the visible laser.

In one embodiment, the wavefront detection system the target laser being incident to the grating 3 with a target angle. Therefore, when setting the grating 3, the attitude of the grating 3 is adjusted, so that the angle between the visible laser and the grating 3 keep a target angle. In this way, the target laser is incident to the grating 3 with a target angle.

In one embodiment, the wavefront detection system is perpendicularly incident to the imaging sensor 62. Therefore, when setting the imaging sensor 62, the attitude of the imaging sensor 62 is adjusted, so that the visible laser is perpendicular to the imaging sensor 62. In this way, the target laser is perpendicular to the imaging sensor 62 with the guidance of the visible laser.

It should be noted that since the imaging sensor 62 is set inside the camera 6, the attitude of the imaging sensor 62 is mainly adjusted by adjusting the attitude of the camera 6.

It should also be noted that since the imaging sensor 62 is set inside the camera 6 and where the area before the imaging sensor 62 is usually provided with various lens elements, the attitude of the imaging sensor 62 cannot be directly observed. However, since the various lens elements arranged in the area preceding the imaging sensor 62 are generally parallel to the imaging sensor 62, the attitude of the imaging sensor 62 can be determined indirectly by observing the attitude of the forefront lens element 61 (e. g. the protective lens set in the front of the camera 6).

It should be understood that according to the specific wavefront detection method provided by the emotional, the wavefront detection system may also require that the target laser be incident to the imaging sensor 62 with a target angle. In this situation, when setting the imaging sensor 62, the attitude of the imaging sensor 62 is adjusted, so that the visible laser and the imaging sensor 62 keep a target angle. In this way, the target laser is incident to the imaging sensor 62 with the guidance of the visible laser.

In one embodiment, the building method of the optical path provided by the present application includes: when setting the sample to be detected 2 on the optical path, the attitude of the sample to be detected 2 is adjusted, so that the target laser perpendicular to sample to be detected 2 and pass through the center of the sample to be detected 2.

Specifically, in the present embodiment, when the sample to be detected 2 is set on the optical path, the attitude of the sample to be detected 2 is adjusted, so that the target laser perpendicular to sample to be detected 2 and pass through the center of the sample to be detected 2. In this way, with the guidance of the visible laser, the target laser is also perpendicular to sample to be detected 2 and passes through the center of sample to be detected 2.

In one embodiment, “setting the target laser and the visible laser emitted by the visible light source 11 coaxially” includes:
detecting a relative position between a spot of the target laser at a first spatial location and a spot of the visible laser, and detecting a relative position between a spot of the target laser at a second spatial location and a spot of the visible laser;
based on the detected relative position, adjusting the target laser and the visible laser to achieve coaxial alignment;
upon achieving coaxial alignment of the target laser and the visible laser, ensuring that the spots coincide at both the first and second spatial locations.

In the present embodiment, the relative position of the spots is the reference to set the target laser and the visible laser coaxially.

Specifically, in the present embodiment, two spatial locations (the first spatial location and the second spatial location) may be determined in advance. It should be understood that two points can determine a straight line, therefore if both the target laser and the visible laser pass through the first spatial location and the second spatial location, it indicates that the target laser is coaxial with the visible laser at least in the coaxial portion between the first spatial location and the second spatial location.

Therefore, the propagation path of at least one of the target laser and the propagation path of the visible laser are adjusted, and then the spot of the target laser and the spot of the visible laser at the first spatial location are detected, so that the relative position between the two spots at the first spatial location is detected. And the spot of the target laser and the spot of the visible laser are also detected at the second spatial location, so as to detect the relative position between the two spots at the second spatial location.

Whether the two spots at the first spatial location overlap is determined based on the relative position between the two spots at the first spatial location; similarly, whether the two spots at the second spatial location overlap is determined based on the relative position between the two spots at the second spatial location.

If the two spots don't overlap at the first spatial location, or if the two spots don't overlap at the second spatial location, the propagation path of at least one of the target laser and the visible laser is further adjusted until the two spots overlap at the first spatial location and at the second spatial location. Thus, the target laser and the visible laser both pass through the first spatial location and the second spatial location simultaneously, and the target laser and the visible laser are set coaxially.

It should be noted that the laser spots can be detected based on the visual performance of laser spots, or the laser spots can be detected by the photoelectric performance or photochemical performance of laser spots.

Because the visible laser itself can be perceived by the vision, when detecting the laser spot by visual expression, it mainly refers to the position of the target laser spot in the form of visible light. When detecting the spot of the target laser by visual performance, the spot of the target laser can be detected by using a laser display card dedicated to detect the target laser. Specifically, when the target laser shines on the laser display card, it will excite the elements in the corresponding area of the laser display card to emit visible light, so that the laser display card will show the location of the spot of the target laser. At the same time, because the laser display card can reflect visible light, when the visible laser shines the laser display card, the visible laser spot naturally projected on the laser display card can be sensed by the vision directly. Therefore, the laser display card is used to detect both the spot of the target laser and the spot of the visible laser.

When detecting the laser spot by photoelectric performance, the photo-resistor or other photosensitive electronic components that can convert the optical signal into electrical signal can be used to detect the laser spot (may be the visible laser or the target laser) at the corresponding waveband. Specifically, after the laser at the corresponding waveband is illuminated on the photosensitive electronic element, a specific electrical signal is excited in the spot area. The spot area can be located to determine the location of the spot by processing the electrical signals.

When detecting the laser spot by the photochemical performance, the sensitive film or other photosensitive material components which can be caused material properties by illuminating (such as the material color, the material solubility, etc.), the corresponding waveband of the laser (which can be a visible laser or a target laser) spot is detected. Specifically, after the laser at the corresponding waveband is illuminated on the photosensitive material component, the spot area will correspond the laser to change the performance of the material. The spot area can be located to determine the location of the spot by detecting the area of the material properties.

It should be noted that when detecting the spot of the target laser and the spot of the visible laser, the two spots may be detected by the same detection method, or the two spots may be detected by the different methods. For example, both the spots of the target laser and the visible laser may be detected by the visual performance. The spot of the visible laser may be detected by the visual performance, at the same time the spot of the target laser may be detected by the photoelectric performance. The spot of the visible laser may be detected by the photoelectric performance, at the same time the spot of the target laser may be detected by the visual performance. Similarly, other alternative combinations of detection routes will not be repeated.

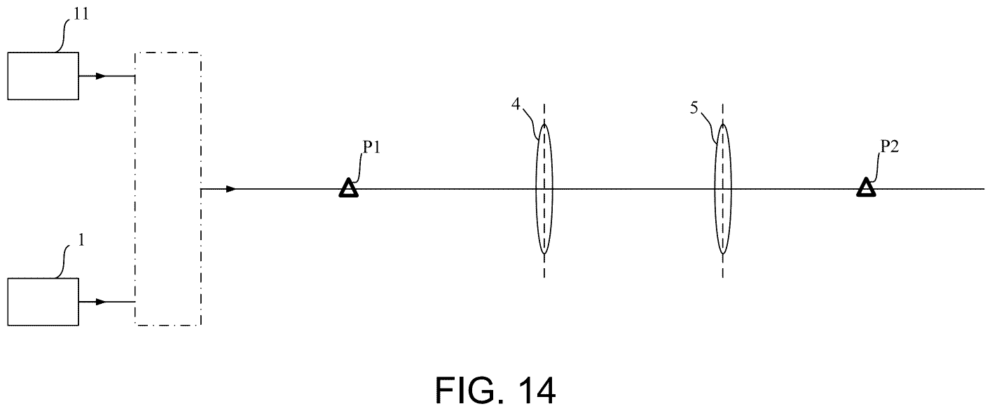

FIG. 14 shows a schematic diagram of building the optical path by using the visible laser and adjusting the first spatial location P1 and the second spatial location P2 as a reference in the first embodiment.

Referring to FIG. 14, in one embodiment, the first spatial location P1 and the second spatial location P2 are selected in the coaxial portion between the target laser and the visible laser. When the front lens 4 and the rear lens 5 are set on the optical path and the attitude of the front lens 4 and the rear lens 5 are adjusted to the target attitude, the front lens 4 and the rear lens 5 are set between the first spatial location P1 and the second spatial location P2. Thus, the first spatial location P1 is located in front of the front lens 4, and the second spatial location P2 is located behind the rear lens 5.

In the present embodiment, “with the guidance of the visible laser, setting the grating that is incident vertically by the target laser, the 4f lens group and the camera 6” includes:
based on a position deviation between the visible laser reflected by the 4f lens group and the first spatial location, and based on a position deviation between the visible laser from the 4f lens group and the second spatial location, adjusting an attitude of the front lens and an attitude of the rear lens, so that the target laser is incident to the front lens and the rear lens perpendicularly and passes through the center of the front lens and the rear lens.

Specifically, in the present embodiment, the front lens 4 is set between the first spatial location P1 and the second spatial location P2. After the visible laser being incident to the front lens 4, a part of the visible laser will be reflected by the front lens 4 and other part of the visible laser will be transmitted by the front lens 4. Similarly, the rear lens 5 will be set between the first spatial location P1 and the second spatial location P2, and a part of the visible laser will be reflected by the front lens 4 and other part of the visible laser will be transmitted by the front lens 4.

Therefore, the attitudes of the front lens 4 and the rear lens 5 are adjusted, so that the deviation of the relative position between the visible laser reflected by the 4f lens and the first spatial location P1 is less than the deviation threshold and the deviation of the relative position between the visible laser reflected by the 4f lens and the second spatial location P2 is less than the deviation threshold. Thus, the visible laser vertically passes through the center of the front lens 4 and the center of the rear lens 5, and the target laser vertically passes through the center of the front lens 4 and the center of the rear lens 5.

It should be noted that when adjusting the attitude of the front lens 4 and the rear lens 5, the front lens 4 may be set firstly (that is, the attitude of the front lens 4 may be adjusted to the target attitude satisfied the target requirements of the wavefront detection system firstly), and then rear lens 5 may be adjusted (that is, the attitude of the rear lens 5 may be adjusted to the target attitude satisfied the target requirements of the wavefront detection system). In one embodiment, the rear lens 5 may be set firstly (that is, the attitude of the rear lens 5 may be adjusted to the target attitude satisfied the target requirements of the wavefront detection system firstly), and then the front lens 4 may be adjusted (that is, the attitude of the front lens 4 may be adjusted to the target attitude satisfied the target requirements of the wavefront detection system). In one embodiment, the attitude of the front lens 4 and the rear lens 5 may be adjusted at the same time.

It should be noted that during the adjusting process, when there is only the front lens 4 set between the first spatial location P1 and the second spatial location P2, the visible laser reflected by the 4f lens group is the visible laser reflected by the front lens 4 and the visible laser transmitted by the 4f lens group is the visible laser transmitted by the front lens 4. When there is only the rear lens 5 set between the first spatial location P1 and the second spatial location P2, the visible laser reflected by the 4f lens group is the visible laser reflected by rear lens 5 and the visible laser transmitted by the 4f lens group is the visible laser transmitted by rear lens 5. When the front lens 4 and the rear lens 5 are set between the first spatial location P1 and the second spatial location P2, the visible laser reflected by 4f lens group is the visible laser mainly reflected by rear lens 5 and the visible laser transmitted by the 4f lens group is the visible laser transmitted by the front lens 4 and transmitted by the rear lens 5.

It should be noted that due to the wavefront detection system aims at the target laser for the wavefront detection, each of the front lens 4 and the rear lens 5 has a high transmittance, which leads to the target lasers reflected by the front lens 4 and the rear lens 5 being too less. In this way, the reflected target laser is difficult to perform detection. Therefore, although the target laser will be reflected/transmitted by the front lens 4 and the rear lens 5, the reflected/transmitted target laser is not selected to detect position deviation, but the reflected/transmitted visible laser is used to detect position deviation.

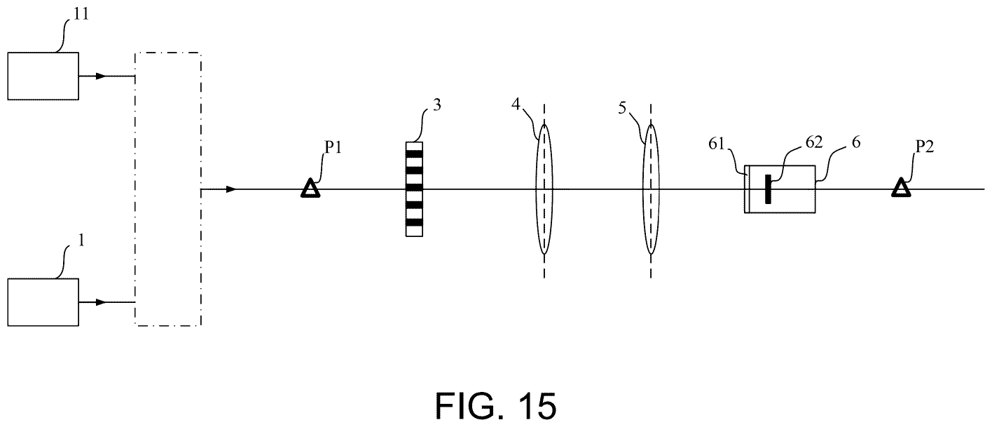

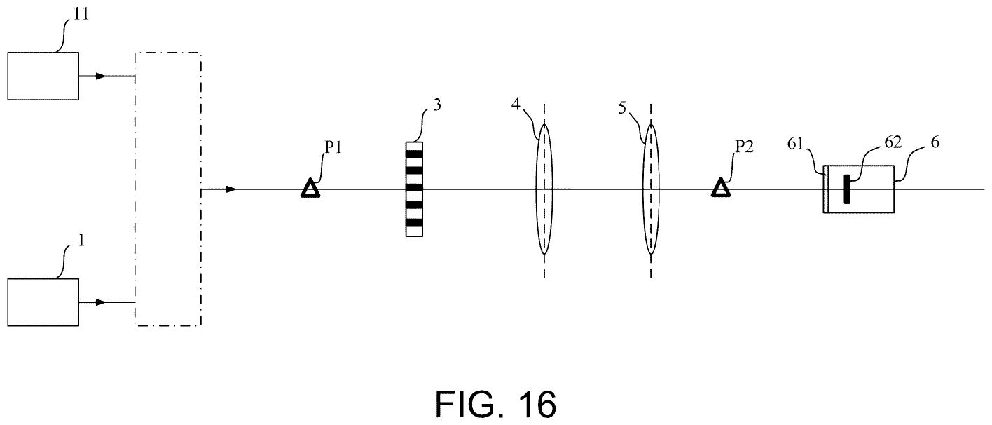

FIG. 15 shows a schematic diagram of building the optical path with the visible laser light as a guide when adjusting each element with a reference of the first spatial location P1 and the second spatial location P2 in an embodiment. FIG. 16 shows a schematic diagram of building the optical path with the visible laser as a guide when adjusting each element with a reference of the first spatial location P1 and the second spatial location P2 in an embodiment.

As shown in FIG. 15 and FIG. 16, in one embodiment, in the coaxial portion of the first spatial location P1 and the visible laser, and the second spatial location P2 are selected, and the grating 3, 4f lens group and the camera 6 are provided in the optical path to adjust the position of these elements to the target position (at this moment, whether the distance between these components meets the target requirements can be not considered). At least the grating 3 and 4f lens groups are provided between the first spatial location P1 and the second spatial location P2, so that the first spatial location P1 is in front of the grating 3 and the second spatial location P2 is set at least rear of the 4f lens group (that is, is set behind the rear lens 5). In detail, the second spatial location P2 may be located not only behind the rear lens 5 but also behind the camera 6, or the second spatial location P2 may be located not only behind the rear lens 5 but also in front of the camera 6.

In this embodiment, “with the guidance of the visible laser, setting the grating 3, the 4f lens group and the camera 6 on the optical path in sequence” includes:
based on the position deviation of the visible laser reflected by the grating 3 relative to the first spatial position P1, adjusting the attitude of the grating 3 so that the target laser perpendicularly incident the grating 3;
based on the position deviation of the visible laser reflected by the camera 6, adjusting the attitude of the camera 6, so that the target laser is perpendicularly incident to the camera 6; when the second spatial location P2 is located behind the camera, the anterior spatial location is the first spatial location P1; when the second spatial location P2 is located in front of the camera 6, the anterior spatial location is the first spatial location P1 and the second spatial location P2.

Specifically, in the present embodiment, the grating 3 is set between the first spatial location P1 and the second spatial location P2. Preferably, the grating 3 has a high transmittance for the target laser, and the grating has a high reflectivity for the visible laser (for example, when the target waveband is far-infrared waveband, the grating 3 is preferably made of silicon, so that the grating 3 has a high transmittance for the infrared laser and a high reflectivity for the visible laser). In this situation, the visible laser is basically reflected by the grating 3 after the grating 3 being incident by the visible laser, and the attitude of the grating 3 is adjusted so that the position deviation between the visible laser reflected by the grating 3 and the first spatial location P1 is less than the deviation threshold, so that the visible laser reflected by the grating 3 does not deviate from the first spatial location P1, which makes the visible laser be perpendicularly incident grating 3, and also the target laser perpendicularly the incident grating 3.

In the present embodiment, when the second spatial location P2 is located behind the camera 6, the camera 6 is set between the first spatial location P1 and the second spatial location P2; in this situation, the first spatial location P1 is located behind the camera 6. When the second spatial location P2 is located in front of the camera 6, the anterior spatial location of the camera 6 is the first spatial location P1. When the second spatial location P2 is located in front of the camera 6, the anterior spatial location of the camera 6 may be the first spatial location P1 or may be the second spatial location P2.

Similar to the attitude adjustment of the grating 3, it is necessary to confirm whether the camera 6 is perpendicular to the target laser only based on whether the visible laser reflected by the camera 6 deviates from the anterior spatial location. Therefore, the attitude of the camera 6 is adjusted, so that the relative position deviation between the visible laser reflected by the camera 6 and the anterior spatial location is less than the deviation threshold. In this way, the visible laser reflected by the camera 6 will not deviate from the anterior spatial location, so that the visible laser is perpendicularly incident to the camera 6 and the target laser is perpendicularly incident to the camera 6.

It should be noted that when the grating 3 has a high transmittance for the visible laser, for other elements (e.g. 4f lens group, camera 6), the grating 3 will block the visible laser. In this situation, with the guidance of the visible laser, the attitude of other elements will be adjusted firstly, and then the attitude of the grating 3 is adjusted.

It should be noted that in the present embodiment, after determining the front lens 4, the rear lens 5 and the target waveband, the focal length f1 of the front lens 4 at the target waveband and the focal length f2 of the rear lens 5 at the target waveband are determined.

Therefore, the distance between each element may be adjusted to target state satisfied the requirements of the system by a device which can measure the fixed distance between the two points accurately. In detail, when the position of the imaging sensor 62 in the camera 6 is determined by the device which can measure the fixed distance between the two points accurately, the imaging sensor 62 is controlled to locate behind the rear lens 5 and have a distance of f2. In this way, the imaging sensor 62 is located on the rear focal plane 5B. Similarly, the front lens 4 is located in front of the rear lens 5 and has a distance from the rear lens 5 of (f1+f2), so that the rear focal plane 4B of the front lens 4 at the target waveband coincides with the front focal plane 5A of the rear lens 5. Similarly, the grating 3 is located in front of the front lens and has a distance of L (L>f1) from the front lens 4, so that the front focal plane 4A of the front lens 4 at the target waveband is set between the grating 3 and the front lens 4.

However, if there is no device which can measure the fixed distance between the two points accurately (for example, there is no device which can measure the fixed distance between the two points accurately or the accuracy of the device can't satisfy the requirements of the wavefront detection system), it is difficult to adjust the distance between each element to the target state satisfied the requirements of the wavefront detection system. In one embodiment, “controlling the imaging sensor 62 of the camera locate on the rear focal plane 5B of the rear lens 5 at the target waveband” includes:
setting the rear lens, then setting the camera, and then setting the front lens;
when setting the camera, controlling the imaging sensor locate at the rear focal plane of the rear lens at the target waveband based on the spot that the imaging sensor sensed.

Specifically, in the present embodiment, both the front lens 4 and the rear lens 5 of the 4f lens group are the focusing lens. Therefore, if the rear lens 5 is set before setting the front lens 5, the target laser which can be regarded as the parallel laser is incident to the rear lens 5, and after the target laser passing through the rear lens 5 will be focused firstly; when the target laser transfers to the rear focal plane 5B of the rear lens 5, the target laser has the highest focusing degree; and then the target laser keeps propagating, the target laser will be diverged.

Therefore, if the rear lens 5 is set before setting the front lens 5, the imaging sensor 63 is located on the rear focal plane 5B of the rear lens 5 at the target waveband, the spot sensed by the imaging sensor 32 is largest or has the maximum brightness.

Therefore, in the present embodiment, when setting the 4f lens group and the camera 6, the rear lens 5 is set firstly, and then the camera 6 is set. When setting the camera 6, the front lens 4 hasn't been set.

Therefore, when setting the camera 6, the brightness of the spot sensed by the imaging sensor 62 is detected, and the camera 6 is set on the position where the brightness of the spot is greatest. In this way, the imaging sensor 62 may be set on the rear focal plane 5B of the rear lens 5 at the target waveband. When setting the camera 6, the camera 6 may be set on the position where the brightness of the spot is smallest based on the brightness of the spot sensed by the imaging sensor 62, thus controlling the imaging sensor 62 locate on the rear focal plane 5B of the rear lens 5.

In one embodiment, the rear lens 5 is set firstly, and then the camera 6 is set, next, the front lens 4 is set. And when adjusting the attitude of the 4f lens group based on the first spatial location P1 and the second spatial location P2 (for example, the attitudes of the front lens 4 and the rear lens 5 are adjusted based on the position deviation between the visible laser reflected by the visible laser and the first spatial location, and based on the position deviation between the second spatial location and the visible laser reflected by the 4f lens group). The first spatial position P1 is located in front of the front lens 4, and the second spatial position P2 is located behind the camera 6. Therefore, when the camera 6 is located on the optical path, for the front lens 4, the camera 6 will block the second spatial location P2. Therefore, after “controlling the imaging sensor locate behind the rear focal plane of the rear lens at the target waveband”, the building method of the optical path further includes:
removing the camera 6 from the optical path, and then setting the front lens 4 based on the first spatial location P1 and the second spatial location P2, and adjusting the attitude of the front lens at least;
moving the camera back to the optical path after setting the front lens.

Specifically, in the present embodiment, after controlling the imaging sensor 62 locate on the rear focal plane 5B of the rear lens 5 at the target waveband, the camera 6 is moved from the optical path, thus avoiding the camera 6 blocking the second spatial location P2. Further, the front lens 4 can be set based on the first spatial location P1 and the second spatial location P2, and the attitude of the front lens 4 is adjusted to the target state. After setting the front lens 4, the camera 6 is moved back to the optical path.

It should be noted that when moving the camera 6 from the optical path, the rear focal plane 5B of the rear lens 5 at the target waveband may be marked. Thus, the camera 6 may be moved back to the optical path correctly with the mark as a reference. Optionally, the camera 6 may be removed from the optical path in the first direction by a slide or other reciprocating mechanism, and the camera 6 is moved back to the optical path in the second direction after the front lens 4. The second direction is in the opposite direction of the first direction.

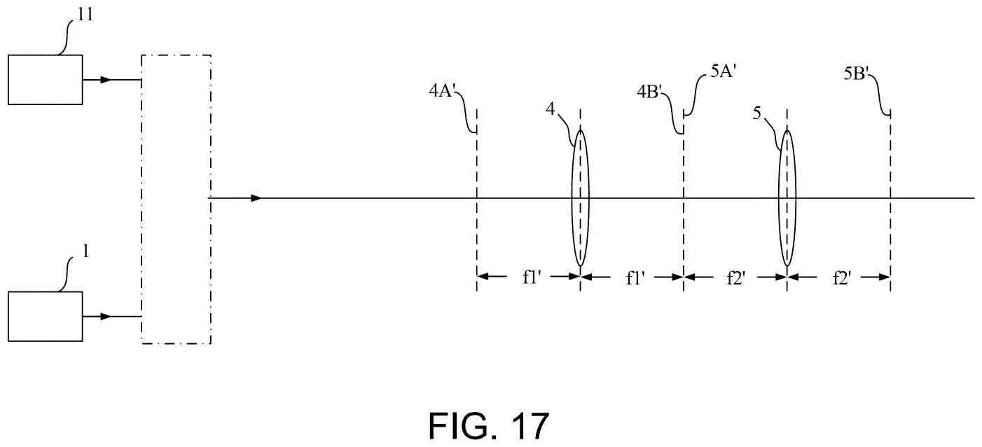

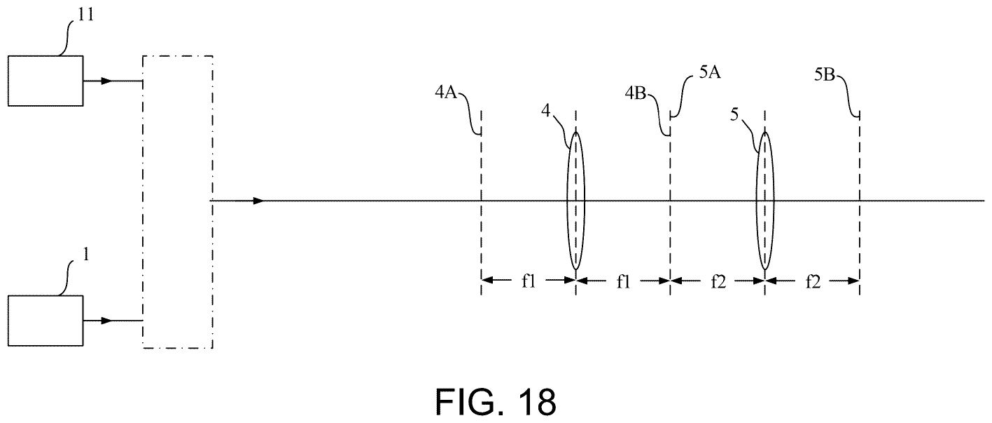

FIG. 17 shows a schematic diagram of building method of the optical path when controlling the distance between the front lens 4 and the rear lens 5 with the guidance of the visible laser in one embodiment of the present application. FIG. 18 shows a schematic diagram of the building method of the optical path when controlling the distance between the front lens 4 and the rear lens 5 with the guidance of the visible laser in one embodiment of the present application.

As shown in FIG. 17, in one embodiment, the focal length of the front lens 4 at the visible waveband is recorded as f1′, and the front focal plane of the front lens 4 at the target waveband is recorded as 4A′, and the rear focal plane of the rear lens 5 at the target waveband is recorded as 4B′. The distance between the front lens 4 and the front focal plane 4A′ is f1′, and the distance between the front lens 4 and the rear focal plane 4B′ is f1′. The focal length of the rear lens 5 at the visible waveband is f2′, and the front focal plane of the rear lens 5 is recorded as 5A′, and the rear focal plane 5B′ of the rear lens 5 at the visible wavefront. The distance between the rear lens 5 and the rear focal plane is f2′, and the distance between rear lens 5 and the rear focal plane 5B′.

In order to adjust the distance between the front lens 4 and the rear lens 5 to the target state satisfied the requirements of the fixed distance between the two points without the device which can measure the fixed distance between the two points, in one embodiment, the visible laser can pass through the first spatial location P1, and pass through the second spatial location P2. As shown in FIG. 7 and FIG. 8, controlling the front lens 4 at the target waveband coincide with the rear lens 5 includes:
obtaining a first target distance between the front lens and the rear lens and a second target distance between the front lens and the rear lens, and obtaining the distance difference between the first target distance and the second target distance;
when the front lens and the rear lens keep the first target distance, the rear focal plane of the front lens at the visible waveband coincides with the front focal plane of the rear lens at the visible waveband;
when the front lens and the rear lens keep the second target distance, the rear focal plane of the front lens at the visible waveband coincides with the front focal plane of the rear lens at the visible waveband;
based on the spot size of the visible laser at the first spatial location and the spot size of the visible laser at the second spatial location, adjusting a distance between the front lens and the rear lens to the first target distance; and then based on the distance difference, adjusting the first target between the front lens and the rear lens to the second target distance.

Specifically, as mentioned above, after determining the front lens 4, the rear lens 5 and the target waveband, the focal length f1 of the front lens 4 at the target waveband and the focal length f2 of the rear lens 5 at the target waveband are determined. Similarly, after determining the visible waveband, the focal length f1′ of the front lens 4 at the visible waveband and the focal length f2′ of the rear lens 5 are further determined.

In the present embodiment, the first target distance between the front lens 4 and the rear lens 5 is (f1′+f2′), the second target distance is (f1+f2). Obviously, when the distance between the front lens 4 and the rear lens 5 keeps the first target distance of (f1′+f2′), the rear focal plane 4B′ of the front lens 4 coincides with the front focal plane 5A′ of the rear lens 5. When the distance between the front lens 4 and the rear lens 5 keep the second target distance of (f1+f2), the rear focal plane 4B of the front lens 4 at the target waveband coincides with the front focal plane 5A of the rear lens 5.

It should be noted that if the spot size is measured by the radius, the spot size of the visible laser at the first spatial location is R1, and the spot size of the visible laser at the second spatial location P2 is R2. When the attitude of the front lens 4 and the attitude of the rear lens 5 satisfy the requirements of the system. And when the front lens 4 and the rear lens 5 keep the first distance of (f1′+f2′), the relative relationship between the R1 and R2 can be determined previously.

Therefore, the distance between the front lens 4 and the rear lens 5 is adjusted, and then the spot of the visible laser at the first spatial location P1 and the spot of the visible laser the second spatial location P2 are detected to determine R1 and R2. Next, R1 and R2 are detected to determine whether the relative relationship between R1 and R2 satisfies the target relative relationship. If the relative relationship between R1 and R2 doesn't satisfy the target relationship, the distance between the front lens 4 and the rear lens 5 is adjusted again, till the distance between the front lens 4 and the rear lens 5 satisfied the target relative relationship. In this way, the distance between the front lens 4 and the rear lens 5 will keep the first target distance of (f1′+f2′).

After enabling the distance between the front lens 4 and the rear lens 5 keep the first target distance of (f1′+f2′), the distance between the front lens 4 and the rear lens 5 may be adjusted to the second target distance of (f1+f2) by using a device that can change the relative distance accurately based on the difference between the first target distance of (f1′+f2′) and the second target distance of (f1+f2). In this way, the rear focal plane 4B of the front lens 4 coincides with the front focal plane 5A of the rear lens 5 at the target waveband.

In one embodiment, the first spatial location P1 that the visible laser passed through is located in front of the front lens 4; the second spatial location P2 the visible laser passed through is located behind the rear lens 5.

Specifically, when the rear focal plane 4B′ of the front lens 4 at the visible waveband coincides with the front focal plane 5A′ of the rear lens 5 at the visible waveband, R1/R2=f1′/f2′. Because f1′ and f2′ can be determined previously, the target value of R1/R2 (that is, f1′/f2′) can be determined previously.

Therefore, in the present embodiment, to detect if R1/R2 satisfies the target relative relationship, it is determined whether R1/R2 reaches the target value. If R1/R2 hasn't reached the target value, it indicates that the relationship of R1/R2 hasn't satisfied the target relative relationship. If R1/R2 reaches the target value, it indicates that the relationship of R1/R2 satisfies the target relative relationship.

However, when the rear focal plane 4B′ of the front lens 4 at the visible waveband doesn't coincide with the front focal plane 5A′ of the rear lens 5 at the visible waveband, after the visible laser passing through the 4f lens group, the visible laser may be focused firstly, and then diverged. In the process from focus to divergence, there is a particular spatial location. When the second spatial location P2 coincides with that particular spatial position, R1/R2=f1′/f2′. In this situation, the rear focal plane 4B ‘of the front lens 4 at the visible waveband coincides with the front focal plane 5A’ of the rear lens 5 at the visible waveband. It can be seen that if the first spatial location P1 is set in front of the front lens 4, the second spatial location P2 is set behind the rear lens 5, and the condition of R1/R2=f1′/f2′ is used to determine whether the relative relationship between R1 and R2 is met may cause miscalculation.

To avoid this kind of miscalculation, in one embodiment, both the first spatial location P1 that the visible laser passed through and the second spatial location P2 are located behind the rear lens 5.

Specifically, when the rear focal plane 4B′ of the front lens 4 coincides with the front focal plane 5A′ of the rear lens 5 and the optical path hasn't been set with the sample to be detected 2, the visible laser is incident to the 4f lens group parallelly, and then is outgoing from the 4f lens group parallelly.

Therefore, in the present embodiment, when the rear focal plane 4B′ of the front lens 4 at the visible waveband coincides with the front focal plane 4A′ of the rear lens 5 at the visible waveband, R1=R2.

And the rear focal plane 4B′ the front lens 4 at the visible waveband will not coincide with the rear focal plane 5A′ of the rear lens 5. After the visible laser passing through the 4f lens group, the visible laser will be focused and then diverges. During this process, the beams behind the rear lens 5 at a distance of L′ (the distance L′ may be determined by the distance between the front lens 4 and the rear lens 5) will keep diverging. Therefore, as long as the distance between the first spatial location P1 and the rear lens 5 is greater than L′, the distance between the second spatial location P2 and the rear lens 5 is greater than L′. In this situation, R1 is not equal to R2.

Therefore, in the present embodiment, when verifying that the relationship between R1 and R2 satisfies the target relative relationship, an additional detection is performed to determine if R1 and R2 have the same value. If R1 is not equal to R2, it indicates that the relationship between R1 and R2 doesn't satisfy the target relative relationship. If R1 is equal to R2, it indicates that the relationship between R1 and R2 satisfies the target relative relationship. In this way, it avoids the miscarriage of the coincidence between the rear focal plane 4B ‘and the front focal plane 5A’.

In order to adjust the distance between the grating 3 and the front lens 4 to the target state without the device that can measure the fixed distance between two points accurately. In one embodiment, “controlling the front focal plane 4A of the front lens 4 locate between the grating 3 and the front lens 4” includes:
after setting the 4f lens group, controlling the grating 3 locate at the front focal plane 4A of the front lens 4 at the target waveband based on the sharpness of the edge of the grating 3 for the image of the imaging sensor 62.
moving the grating 3 forward to a preset distance, so as to make the front focal plane 4A of the front lens 4 locate between the grating 3 and the front lens 4.

Specifically, in the present embodiment, the 4f lens group is set on the optical path firstly, then the grating 3 is set in front of the grating 3. Therefore, the target laser is incident to the grating 3 firstly, and then is incident to the 4f lens group, and finally is incident to the imaging sensor 62 and images. In the image, the edge of the grating 3 is detected.

It should be noted that when the grating 3 is set on the front focal plane 4A of the front lens 4, the sharpness of the edge of the grating 3 imaged at the imaging sensor 62 is highest. Therefore, the grating 3 is located at the front focal plane 4A of the front lens 4. The grating 3 is moved forward to a preset distance, so that the front focal plane 4A of the front lens 4 at the target waveband locates between the grating 3 and the front lens 4.

In one embodiment, after setting the target laser and the visible laser emitted by the visible light source 11 coaxially, and before setting the camera 6, the building method provided in the present application further includes: reducing the optical power of the target laser.

Specifically, because the target laser and visible laser are set coaxially, in order to detect the target laser accurately, the focal power of the target laser needs to be configured greatly. And the imaging sensor 62 of the camera 6 is used to sense the target laser, if the camera 6 is set on the optical path directly, after the imaging sensor 62 being incident by the target laser with greater focal power, it is possible to cause the damage to the imaging sensor 62. Therefore, in this embodiment, after setting the target laser and visible laser coaxially, the optical power of the target laser is reduced before setting the camera 6, thereby avoiding the target laser from causing damage to the imaging sensor 62.

In one embodiment, the optical power of the target laser may be reduced by setting the laser attenuation (the laser attenuator 9 is as shown in FIG. 2) behind the target light source 1.

In one embodiment, the working power of the target light source 1 may be reduced to reduce the optical power of the target laser.

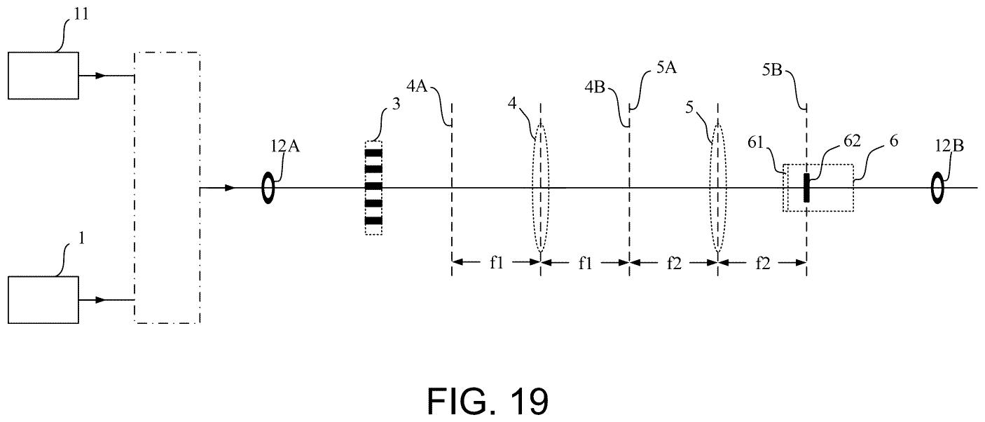

FIG. 19 shows a schematic diagram of building the optical path in one embodiment provided by the present embodiment with the guidance of the visible laser by taking the first aperture 12A and the second aperture 12B as a reference to adjust the attitude of each element.

As shown in FIG. 19, in one embodiment, the building method further includes:
setting the first aperture slot 12A and the second aperture slot 12B, and the straight line passed through the center of the first aperture slot 12A passes through the second aperture slot 12B and is perpendicular to the second aperture slot 12B;
determining the first spatial location P1 based on the position of the first aperture slot 12A, and determining the second spatial location P2 based on the second aperture slot 12B.

Specifically, in the present embodiment, the first aperture slot 12A and the second aperture slot 12B are set. The center of the first aperture slot 12A is at the same line of the center of the second aperture slot 12B, and the line is perpendicular to the first aperture slot 12A and the second aperture slot 12B simultaneously. Thus, if the first aperture slot 12A is set in front of the second aperture slot 12B, a laser at the center of the first aperture slot 12A is also perpendicularly incident the center of the second aperture slot 12B. Therefore, the first spatial location P1 and the second location P2 used to be a reference for the attitude adjustment of the elements by using the first aperture slot 12A and the second aperture slot 12B as a reference.

Specifically, in the present embodiment, the position of the first aperture slot 12A is determined to be the first spatial location P1, the position of the second aperture slot 12B is determined to be the second spatial location P2. In one embodiment, any position near to the first aperture slot 12A on the line between the center of the first aperture slot 12A and the center of the second aperture slot 12B is selected as the first spatial location P1, and any position near to the second aperture slot 12B on the line between the center of the first aperture slot 12A and the center of the second aperture slot 12B is selected as the second spatial location P2.

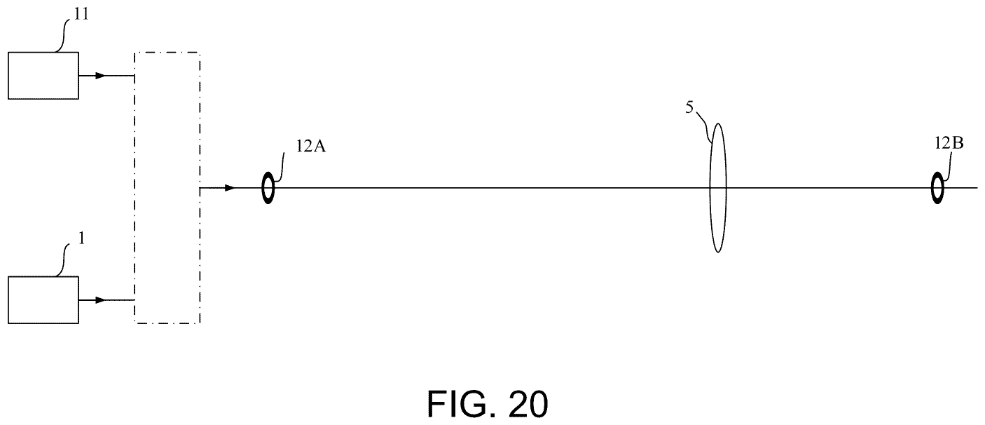

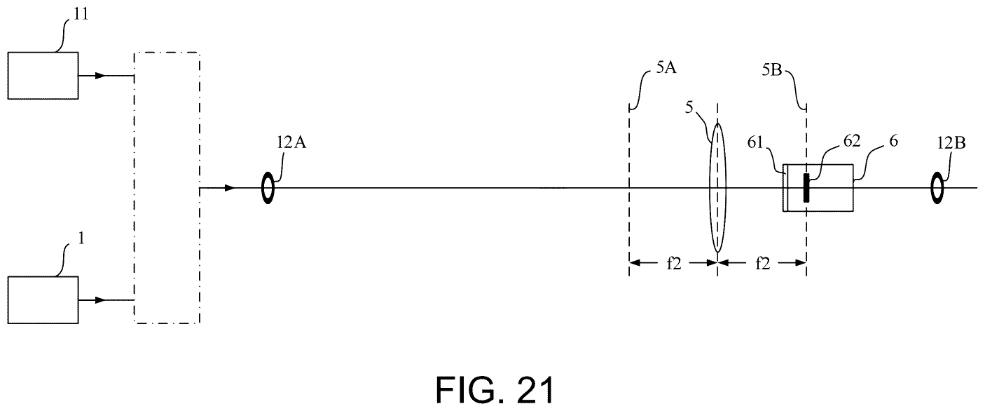

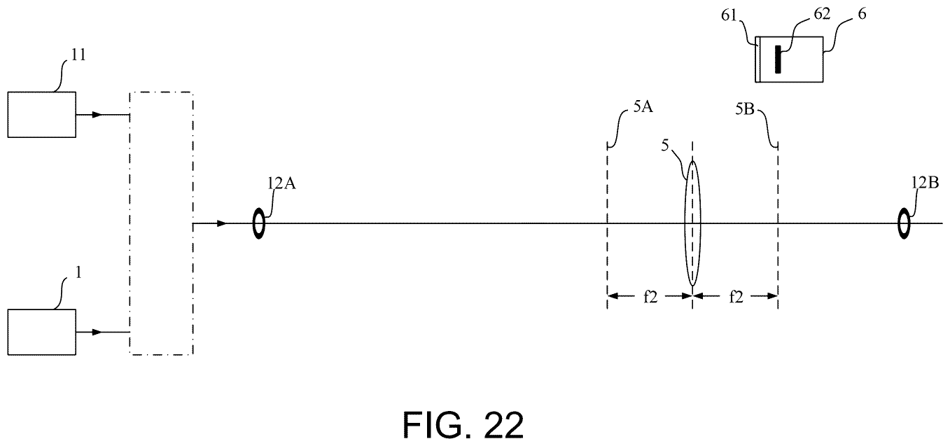

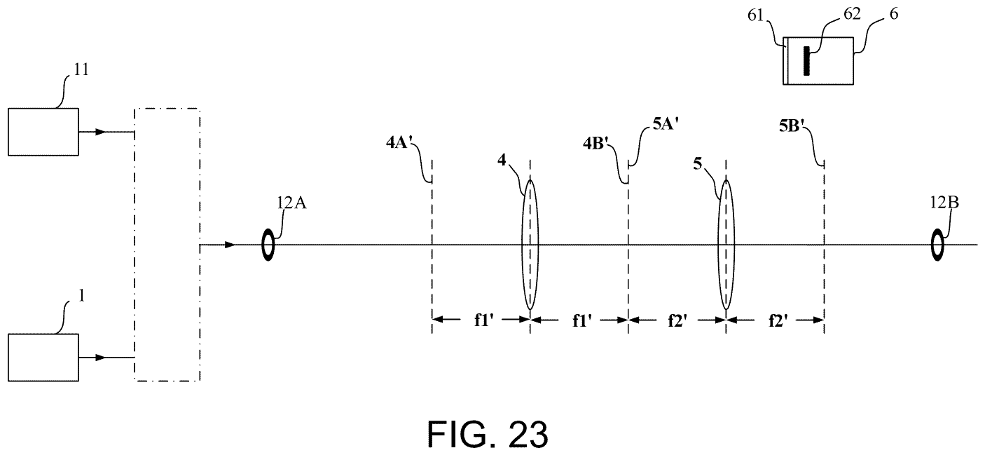

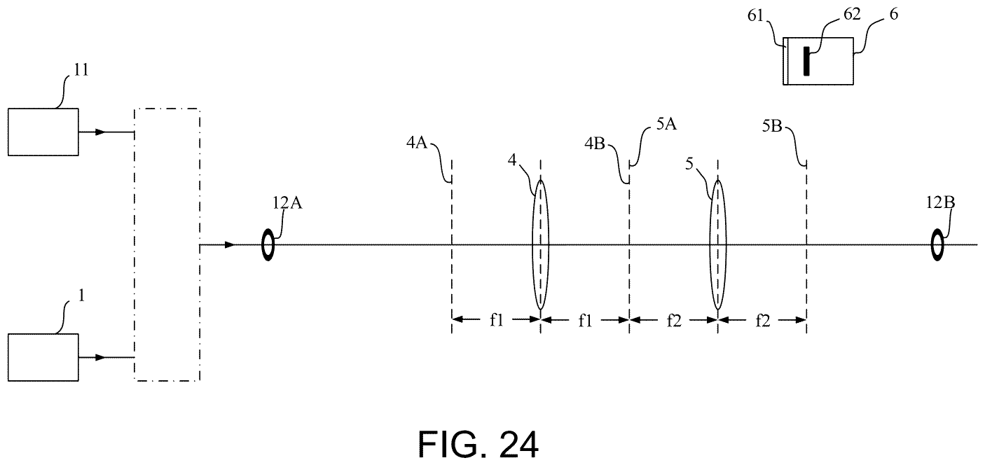

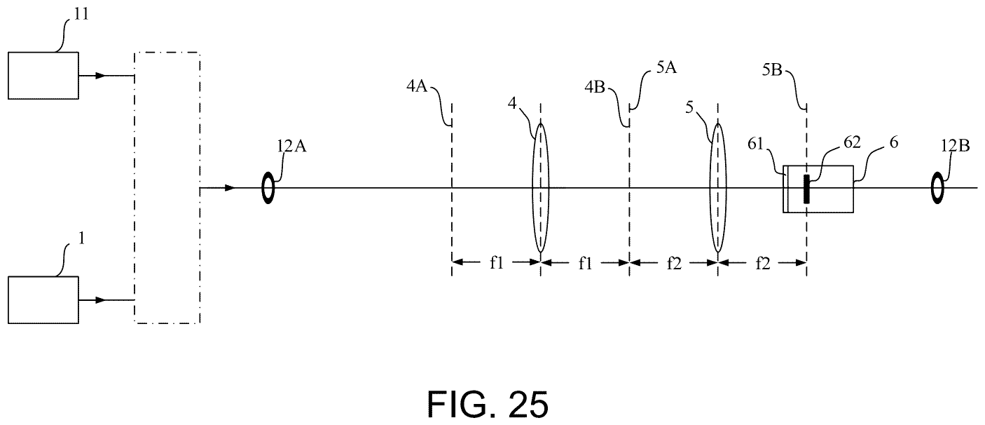

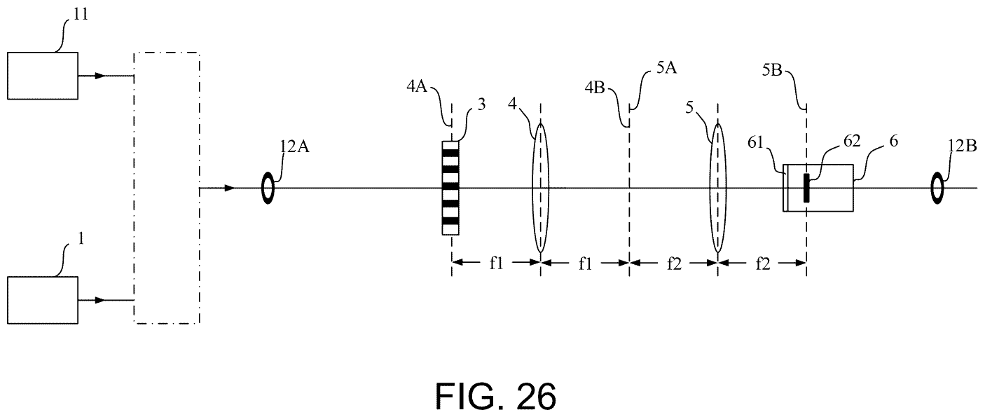

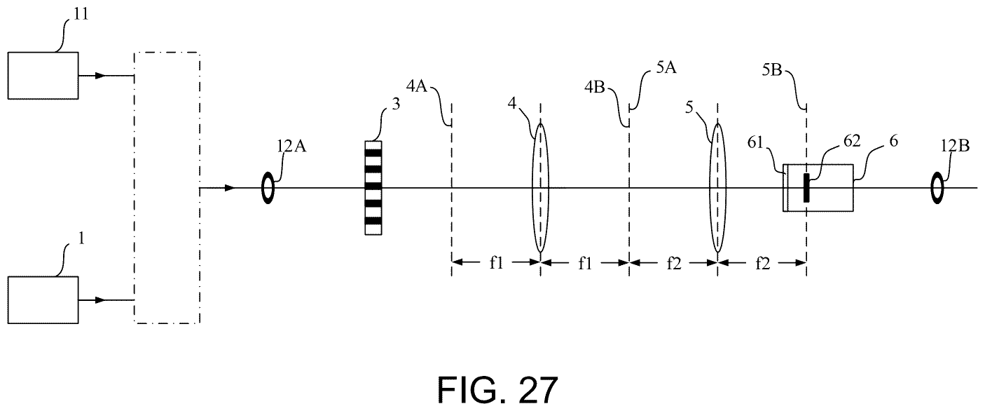

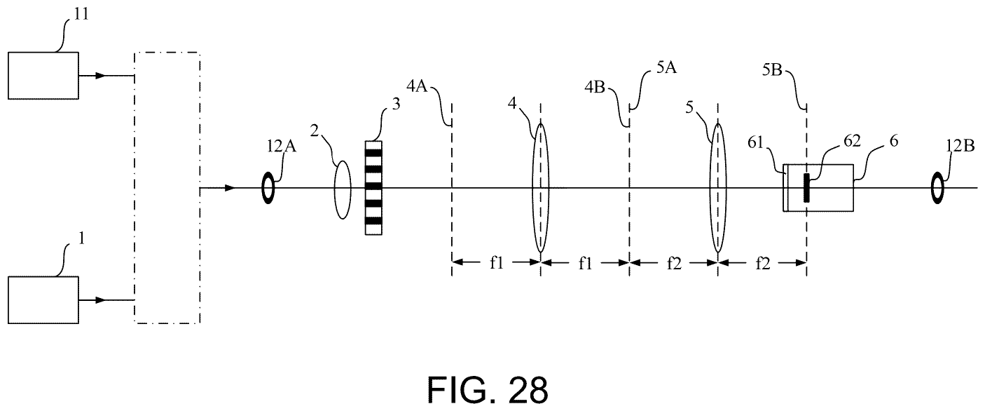

FIG. 20 shows a schematic diagram of the optical path obtained after setting the rear lens 5 with the guidance of the visible laser in one embodiment. FIG. 21 shows a schematic diagram of building the optical path after setting the camera in one embodiment of FIG. 20. FIG. 22 shows a schematic diagram of building the optical path after removing the camera from the optical path in one embodiment of FIG. 21. FIG. 23 shows a schematic diagram of building the optical path after setting the front lens in one embodiment of FIG. 22. FIG. 24 shows a schematic diagram of building the optical path after adjusting the distance between the front lens and the rear lens to set the optical path after setting the 4f lens group. FIG. 25 shows a schematic diagram of building the optical path after moving the camera back to the optical path in the embodiment of FIG. 24. FIG. 26 shows a schematic diagram of building the optical path after setting the grating in the embodiment of FIG. 25. FIG. 27 shows a schematic diagram of building the optical path after adjusting the position of the grating in the embodiment of FIG. 26. FIG. 28 shows a schematic diagram of building the optical path after setting the sample in the embodiment of FIG. 27.

As shown from FIG. 20 to FIG. 28, in one embodiment, the target light source 1 may be a CO₂ laser source, and the central wavelength of the target laser emitted by the CO₂ laser source is 10.6 μm. The central wavelength of the visible laser emitted by the visible light source 1 is 650 nm. Both the front lens 4 and the rear lens 5 of 4f lens group are zinc selenide lenses. And the zinc selenide lens has high transmittance for the target laser and also allows a certain degree of transmittance for the visible laser.

Therefore, in the present embodiment, the first aperture slot 12A and the second aperture slot 12B are set; a line between the center of the first aperture slot 12A and the center of the second aperture slot 12B is perpendicular to the first aperture slot 12A and the second aperture slot 12B.

Then, with the help of the reflective lens and other components, the propagation direction of the target laser is adjusted or the propagation direction of the visible laser is adjusted. At the same time, the spots of the target laser and the visible laser are detected near the first aperture slot 12A by using an infrared detecting card. This detection determines whether the two spots near the first aperture slot 12A coincide.

The propagation direction keeps adjusting, till the two spots coincides with each other near the first aperture slot 12A and the second aperture slot 12B. At this time, the target laser and the visible laser will be coaxial at the first aperture slot 12A and the second aperture slot 12B.

After setting the target laser and the visible laser coaxially, the rear lens 5 is set between the first aperture slot 12A and the second aperture slot 12B. Then the height and the pitching angle of the rear lens 5 are adjusted, so as to adjust the attitude of the rear lens 5. When adjusting the attitude of the rear lens 5, whether the visible laser reflected by the rear lens 5 passes through the center of the first aperture slot 12A is detected, and the visible laser transmitted by the rear lens 5 passes through the center of the second aperture slot 12B is detected.

The attitude of the camera 6 keeps being adjusted, till the visible laser reflected by the camera 6 passes through the center of the aperture slot 12A. At the same time, both the visible laser and the target laser are incident to the camera 6.

Preferably, a laser attenuator 9 is set between the target light source and the grating, and the laser attenuator is configured to reduce the focal power of the target laser. And the camera 6 is set behind the rear lens 5, and then the pitching angle of the camera 6 is adjusted to adjust the attitude of the camera 6. When adjusting the attitude of the camera 6, whether the visible laser reflected by the camera 6 passes through the center of the first aperture slot 12A is detected.

The attitude of the camera 6 keeps being adjusted, till the visible laser reflected by the camera 6 passes through the center of the first aperture slot 12A. At the same time, the visible laser and the target laser are perpendicularly incident to the camera 6.

The position of the camera 6 is adjusted to adjust the distance between the rear lens 5 and the camera 6, and the spot size sensed by the imaging sensor 62 or the spot brightness are detected at the same time.

The distance between the camera 6 and the rear lens 5 is adjusted constantly until the minimum or maximum intensity is detected by the imaging sensor 62. At this time, the imaging sensor 62 is located at the rear focal plane 5B of the rear lens 5 at the target waveband.

The attitude of the camera 6 keeps unchanged, the camera 6 is moved from the optical path.

The front lens 4 is set between the first aperture slot 12A and the rear lens 5, the attitude and the pitching angle of the front lens 4 are adjusted to adjust the attitude of the front lens 4. At the same time, the position of the front lens 4 is adjusted to adjust the distance between the front lens 4 and the rear lens 5. When adjusting the attitude of the front lens 4 and the position, whether the visible laser reflected by the 4f lens group passes through the center of the first aperture slot 12A is detected, and whether the visible laser transmitted by the 4f lens group passes through the center of the second aperture slot 12B is detected. And whether R1/R2 is equal to f1′/f2′ within the allowable error range is detected. R1 is a radius of the spot of the first aperture slot 12A, and R2 is a radius of the spot of the second aperture slot 12B, f1′ is a focal length of the front lens 4 at the visible waveband, f2′ is a focal length of the rear lens 5 at the visible waveband.

The attitude and the position of the front lens 4 keep being adjusted, till the visible laser reflected by the 4f lens group passes through the center of the first aperture slot 12A and the visible laser transmitted by the 4f lens group passes through the center of the second aperture slot 12B, and R1/R2 is equal to f1′/f2′ within an allowable error range. At the moment, both the visible laser and the target laser are perpendicularly incident to the front lens 4 and pass through the center of the front lens 4. And the rear focal plane 4B′ of the front lens 4 coincides with the front focal plane 5A′ of the rear lens 5.

According to the distance difference between the first target distance of (f1′+f2′) and the second target distance of (f1+f2), the position of the front lens 4 is adjusted again, so that the front lens 4 and the rear lens 5 keep the second target distance of (f1+f2). The focal length of the front lens 4 at the target waveband, f2 is the focal length of the rear lens 5 at the target wavelength. Therefore, at this moment, the rear focal plane 4B of the front lens 4 coincides with the front focal plane 5A of the rear lens 5.

The camera 6 is moved back to the optical path with the original attitude.

And the grating 3 is set between the first aperture slot 12A and the front lens 4, and then the pitching angle of the grating 3 is adjusted to adjust the attitude of the grating 3. When adjusting the attitude of the grating 3, whether the visible laser reflected by the grating 3 passes through the center of the first aperture slot 12A is detected.

The attitude of the grating 3 keeps being adjusted, till the visible laser reflected by the grating 3 passes through the center of the first aperture slot 12A. At this moment, both the visible laser and the target laser are perpendicularly incident to the grating 3.

Then the position of the grating 3 is adjusted, and the sharpness of the edge of the grating 3 imaged by the imaging sensor 62 is detected at the same time.

The attitude of the grating 3 keeps being adjusted, till the sharpness of the edge of the grating 3 imaged by the imaging sensor 62 reaches the highest degree. At this moment, the grating 3 is locate at the front focal plane 4A of the front lens 4 at the target waveband.

And then the grating 3 is moved forward to a preset distance, so that the imaging sensor 62 can obtain the high-quality interference image. At this moment, the optical path of the wavefront detection system of the sample to be detected 2 has been built.

Further, when detecting the sample to be detected 2 by using the wavefront detection system, the sample to be detected 2 is set between the first aperture slot 12A and the grating 3. And the pitching angle of the sample to be detected 2 is adjusted to adjust the attitude of the sample to be detected 2. When adjusting the attitude of the sample to be detected 2, whether the visible laser reflected by the sample to be detected 2 passes through the first aperture slot 12A is detected.

The attitude of the sample to be detected 2 keeps being adjusted, till the visible laser reflected by the sample to be detected 2 passes through the center of the first aperture slot 12A. At this moment, both the visible laser and the target laser are incident to the sample to be detected 2, and pass through the center of the sample to be detected 2.

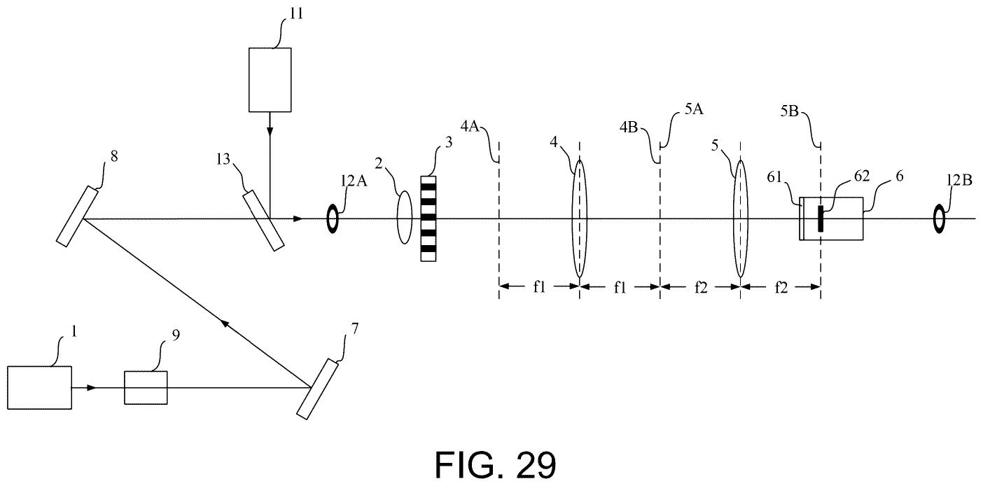

FIG. 29 shows a schematic diagram of building the optical path with the guidance of the visible laser in one embodiment of this application.

As shown in FIG. 29, in one embodiment, because both the weight and the volume of the target light source 1 are greater, it is not suitable to be set vertically, and is not suitable to adjust the attitude directly. Therefore, the first reflective lens 7 and the second reflective lens 8 are set to adjust the propagation direction of the target laser.

Specifically, the visible laser reflected by the first reflective lens 7 are incident to the second reflective lens 8, and then is reflected to the beam-combination lens 13. The beam-combination lens 13 is a reflective-transitive lens. In detail, the beam-combination lens 13 is configured to transmit the incident target laser and reflect the incident visible laser.

Therefore, the target laser and the visible laser are set coaxially by adjusting the angle of the first reflective lens 7, the angle of the second reflected lens 8, the pitching angle of the visible light source 11, the height of the beam-combination 13 and the pitching angle of the beam-combination lens 13 with a reference of the first aperture slot 12A and the second aperture slot 12B. Further, the grating 3, the 4f lens group, and the camera 6 are set according to the building method provided in the above embodiment, so as to build an optical path to achieve the target wavefront detection system. Further, when sample to be detected 2 is detected by using the wavefront detection system, the sample to be detected 2 is set before the grating 3 at a target attitude. And, before setting the camera 6, a laser attenuator 9 is provided between the target light source 1 and the first reflective lens 7 to reduce the optical power of the target laser.

As shown in FIG. 1, the wavefront detection system is provided by the present embodiment. The wavefront detection system uses the building method of the optical path by any above embodiment. As shown the detailed description of FIG. 1, the detailed composition of the wavefront detection system provided in this application will not be described here.

The present application also provides a building device of the optical path for a wavefront detection system. The wavefront detection system includes a target light source for transmitting the target laser in the target waveband; a grating, a 4f lens group and a camera along the propagation direction of the target laser; where the target waveband is outside the visible waveband; the lens sample to be detected between the target light source and the grating; the 4f lens group includes a front lens and a rear lens along the propagation direction of the target laser; and an imaging sensor of the camera for sensing the target laser.

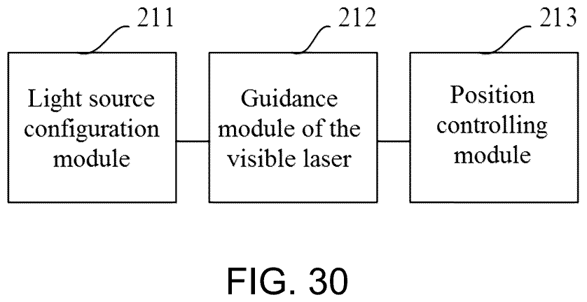

FIG. 30 shows a block diagram of the optical path arrangement for the wavefront detection system provided in this application, referring to FIG. 30, the building method of the optical path includes:
the light source configuration module 211, and the light source configuration module 211 includes the visible laser and the target laser, and the visible laser and the target laser are set coaxially;
the guidance module of the visible laser 212, the guidance module of the visible laser 212 is configured to set the grating, the 4f lens group, and the camera with the visible laser in sequence; the target laser is perpendicular to the front lens and the rear lens, and the target laser passes through the center of the front lens and the center of the rear lens at least;
the position controlling module 213, the position controlling module 213 is configured to control the imaging sensor locate on the rear focal plane of the rear lens at the target waveband, and control the rear focal plane of front lens at the target waveband coincide with the front focal plane of the rear lens, and control the front focal plane of the front lens at the target waveband locate between the grating and the front lens, so as to build and obtain the optical path of the wavefront detection system.

In one embodiment, the building device of the optical path further includes: when setting the sample to be detected on the optical path, the attitude of the sample to be detected is adjusted with the guidance of the visible laser, so that the target laser is perpendicular to the sample and passes through the center of the sample.

In one embodiment provided by the present application, the light source configuration module 211 is configured for:
detecting the relative position between the spot of the target laser at the first spatial location and the spot of the visible laser at the first spatial location, and detecting the relative position between the spot of the target laser at the second spatial location and the spot of the visible laser at the second spatial location;
setting the target laser and the visible laser coaxially based on the relative position of the spots at the first spatial location and the relative spatial position of the spots at the second spatial location; when the target laser and the visible are coaxial, the spot of the target laser at the first spatial location coincides with the spot of the visible laser at the second spatial location.

In one embodiment, the first spatial location that the visible laser passes through is located in front of the front lens; the second location that the visible laser passes through is located behind the rear lens; both the first spatial location and the seconds spatial location are located on the coaxial portion between the target laser and the visible laser;
the guidance module of the visible laser 212 is configured for:
adjusting the attitude of the front lens and the rear lens based on the position deviation between the visible laser reflected by the 4f lens group and the first spatial location, and position deviation between the visible laser transmitted by 4f lens group and the second spatial location, so that the target laser is perpendicularly incident to the front lens and the rear lens and the target laser passes through the center of the front lens and the center of the rear lens.

In one embodiment, the first spatial location that the visible laser passed through is located at the front of the grating; the second spatial location that the visible laser passed through is set behind the 4f lens group; both the first spatial location and the second spatial location are located on the coaxial portion between the target laser and the visible laser. The guidance module of the visible laser 212 is configured for:
adjusting the attitude of the grating based on the position deviation between the visible laser reflected by the grating and the first spatial location, so that the target laser is perpendicularly incident to the grating;
adjusting the attitude of the camera based on the position deviation between the visible laser reflected by the camera and the anterior spatial location; when the second spatial location is set behind the camera, the anterior spatial location is the first spatial location; when the second spatial location is set in front of the camera, the anterior spatial location is the first spatial location or the second spatial location.

In one embodiment provided by the present application, the position controlling module 213 is configured for:
setting the front lens firstly, then setting camera, and then setting the front lens; when setting the camera, controlling the imaging sensor locate at the rear focal plane of the rear lens at the target waveband based on the spot that the imaging sensor sensed.

In one embodiment provided by the present application, the first spatial location that the visible laser passed through is located in front of the front lens; the second spatial location that the visible laser passed through is set behind the camera; both the first spatial location and the second spatial location are located at the coaxial portion between the target laser and the visible laser, and the first spatial location and the second spatial location are configured to adjust the attitude of the 4f lens group. The position controlling module 213 is configured to:
after controlling the imaging sensor locate at the rear focal plane of the rear lens at the target waveband, moving the camera from the optical path, and then setting the front lens based on the first spatial location and the second spatial location and adjusting the attitude of the front lens at least;
after setting the front lens, moving the camera back to the optical path.

In one embodiment, the visible laser passes through the first spatial location, and also passes through the second spatial location; the position controlling module 213 is configured for:
obtaining a first target distance between the front lens and the rear lens, and a second target distance between the front lens and the rear lens, and obtaining the distance difference between the first target distance and the second target distance; when the front lens and the rear lens keep the first target distance, the rear focal plane of the front lens at the visible waveband coincides with the front focal plane of the rear lens at the visible waveband; when the front lens and the rear lens keep the second target distance, the rear focal plane of the front lens at the visible waveband coincides with the front focal plane of the rear lens at the visible waveband;
adjusting a distance between the front lens and the rear lens to the first target distance based on the spot size of the visible laser at the first spatial location and the spot size of the visible laser at the second spatial location; and then based on the distance difference, adjusting the first target between the front lens and the rear lens to the second target distance.

In one embodiment, the first spatial location is located in front of the front lens, and the second spatial location is set behind the rear lens.

In one embodiment, both the first spatial location and the second spatial location are located behind the rear lens.

In one embodiment, the position controlling module 213 is configured for:

After setting the 4f lens group, the front focal plane of the front lens is located between the grating and the front lens.

In one embodiment, a distance between the grating and a front focal plane of the front lens at the target waveband is positively correlated with a period of the grating; and the distance between the grating and a front focal plane of the front lens at the target waveband is inversely correlated with a numerical aperture of the sample to be detected.

In one embodiment, the building device of the optical path further is configured to reduce the focal power of the target laser after setting the target laser and the visible laser coaxially and before setting the camera.

In one embodiment, a size of the sample to be detected is positively correlated with a value of f1/f2; f1 is a focal length of the front lens at the target waveband, and f2 is a focal length of the rear lens at the target waveband.

In one embodiment, a period of the grating is positively correlated with a value of f1/f2; f1 is a focal length of the front lens at the target waveband, and f2 is a focal length of the rear lens at the target waveband.

In one embodiment, the building device of the optical path is configured for setting the first aperture slot and the second aperture slot; the center of the first aperture slot is at the same line of the center of the second aperture slot, and the line is perpendicular to the first aperture slot and the second aperture slot simultaneously;
determining the first spatial location based on the position of the first aperture slot, and determining the second spatial location based on the position of the second aperture slot.

The present application also provides an electronic device. The electronic device is in the form of a universal computing device. The components of an electronic device may include, but are not limited to, at least one processor, at least one memory, and a bus connecting different system components (including memory and processor). The processor may include various modules in the device shown in FIG. 30.

The memory is stored with a program code, which may be executed by the processor, causing the processor to perform the steps of the exemplary embodiments described in the various exemplary embodiments described above. For example, the processor may perform the various steps as shown in FIG. 12.

The memory may include readable media in the form of volatile memory, such as random-access memory (RAM) and/or cache memory, and may further include read-only memory (ROM).

The memory may also include a program/utility having a set of (at least one) of program modules including, but not limited to, the operating system, one or more applications, other program modules, and program data, each or some combination of these examples may include an implementation of a network environment.

A bus may be a local bus representing one or more of several types of bus structures, including a memory bus or memory controller, peripheral bus, graphics acceleration port, processor, or using any bus structure in a variety of bus structures.

The present application also provides a computer-readable storage medium storing computer-readable instructions that cause the computer to execute the method provided by any of the method embodiment when executed by the computer's processor.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. A wavefront detection system, comprising: a target light source configured to emit a target laser at a target waveband; a grating, a 4f lens group and a camera along a propagation direction of the target laser in sequence;
wherein the 4f lens group comprises a front lens and a rear lens along the propagation direction of the target laser in sequence; a rear focal plane of the front lens at the target waveband coincides with a front focal plane of the rear lens at the target waveband,
wherein an imaging sensor of the camera is configured to sense the target laser, and the imaging sensor is set on a rear focal plane of the rear lens at the target waveband,
wherein the grating is set in front of the front focal plane of the front lens at the target waveband, and a sample to be detected is set between the target light source and the grating.

2. The wavefront detection system according to claim 1, wherein the target light source is configured to emit a target laser at a far-infrared waveband, the rear focal plane of the front lens coincides with the front focal plane of the rear lens at the far-infrared waveband,
wherein the imaging sensor is set on the rear focal plane of the rear lens at the far-infrared waveband, and the grating is set in front of the front focal plane of the front lens at the far-infrared waveband;
wherein the sample to be detected works at the far-infrared waveband.

3. The wavefront detection system according to claim 1, wherein the target laser is at least perpendicular to the front lens and the rear lens, and the target laser at least passes through a center of the front lens and a center of the rear lens.

4. The wavefront detection system according to claim 1, wherein a distance between the grating and a front focal plane of the front lens at the target waveband is positively correlated with a period of the grating; and the distance between the grating and the front focal plane of the front lens at the target waveband is inversely correlated with a numerical aperture of the sample to be detected.

5. The wavefront detection system according to claim 1, wherein the period of the grating is 72 μm±3 μm,
wherein when the numerical aperture of the sample to be detected is 0.04, a distance between the grating and a front plane of a front lens is 0.4 mm to 0.8 mm,
wherein when the numerical aperture of the sample to be detected is 0.1, the distance between the grating and a front plane of a front lens is 0.3 mm to 0.45 mm,
wherein when the numerical aperture of the sample to be detected is 0.15, the distance between the grating and a front plane of a front lens is 0.15 mm to 0.25 mm.

6. The wavefront detection system according to claim 1, wherein the period of the grating is 144 μm±3 μm,
wherein when the numerical aperture of the sample to be detected is 0.04, a distance between the grating and a front plane of a front lens is 0.3 mm to 1.8 mm,
wherein when the numerical aperture of the sample to be detected is 0.1, the distance between the grating and a front plane of a front lens is 0.2 mm to 0.75 mm,
wherein when the numerical aperture of the sample to be detected is 0.15, the distance between the grating and a front plane of a front lens is 0.2 mm to 0.45 mm.

7. The wavefront detection system according to claim 1, wherein the period of the grating is 180 μm±3 μm,
wherein when the numerical aperture of the sample to be detected is 0.04, a distance between the grating and a front plane of a front lens is 0.2 mm to 2.3 mm,
wherein when the numerical aperture of the sample to be detected is 0.1, the distance between the grating and a front plane of a front lens is 0.2 mm to 0.9 mm,
wherein when the numerical aperture of the sample to be detected is 0.15, the distance between the grating and a front plane of a front lens is 0.5 mm to 0.6 mm.

8. The wavefront detection system according to claim 1, wherein a size of the sample to be detected is positively correlated with a value of f1/f2,
wherein f1 is a focal length of the front lens at the target waveband, and f2 is a focal length of the rear lens at the target waveband.

9. The wavefront detection system according to claim 1, wherein a period of the grating is positively correlated with a value of f1/f2,
wherein f1 is a focal length of the front lens at the target waveband, and f2 is a focal length of the rear lens at the target waveband.

10. The wavefront detection system according to claim 1, wherein a grating is a mesh 2D grating, and a phase difference between each unit block of the grating is π.

11. The wavefront detection system according to claim 1, wherein a reflective lens group is set between the target light source and the grating, and the reflective lens group is configured to adjust the propagation direction of the target laser,
wherein the reflective lens group further comprises a reflective lens.

12. The wavefront detection system according to claim 1, wherein a laser attenuator is set between the target light source and the grating, and the laser attenuator is configured to reduce a focal power of the target laser.

13. A building method of an optical path, wherein the building method of the optical path is configured to build the optical path for the wavefront detection system according to claim 1, and the building method comprises:
setting a visible light source and a target light source, and setting the target laser and a visible laser emitted by the visible light source coaxially;
with the guidance of the visible laser, setting the grating, the 4f lens group and the camera on the optical path successively, wherein the target laser is at least perpendicular to the front lens and the rear lens, and the target laser at least passes through the center of the front lens and the center of the rear lens;
controlling the imaging sensor locate at the rear focal plane of the rear lens at the target waveband, and controlling the rear focal plane of the front lens coincide with the front focal plane of the rear focal plane at the target waveband; and controlling the front focal plane of the front lens locate between the grating and the front lens, so as to build and obtain the optical path of the wavefront detection system.

14. The building method of the optical path according to claim 13, wherein in the step of setting the target laser and the visible laser emitted by the visible light source coaxially, the step further comprises:
detecting a relative position between a spot of the target laser at a first spatial location and a spot of the visible laser at a second spatial location;
based on the detected relative position, adjusting the target laser and the visible laser to achieve coaxial alignment;
upon achieving coaxial alignment of the target laser and the visible laser, ensuring that the spots coincide at both the first and second spatial locations.

15. The building method of the optical path according to claim 14, wherein the first spatial location that the visible laser passed through is located in front of the front lens, the second spatial location that the target laser passed through is located behind the rear lens, both the first spatial location and the second spatial location are located at a coaxial portion of the target laser and the visible laser,
wherein in the step of with the guidance of the visible laser, setting the grating that is perpendicularly incident by the target laser, the 4f lens group and the camera, the step further comprises:
adjusting an attitude of the front lens and an attitude of the rear lens based on a position deviation between a position of the visible laser reflected by the 4f lens group and the first spatial location, and based on a position deviation between the position of the visible laser from the 4f lens group and the second spatial location, so that the target laser is perpendicularly incident to the front lens and the rear lens and passes through the center of the front lens and the rear lens.

16. The building method of the optical path according to claim 13, wherein the first spatial location that the visible laser passed through is located in front of the grating, and the second spatial location that the target laser passed through is located behind the grating; both the first spatial location and the second spatial location are located at a position of a coaxial portion between the target laser and the visible laser,
wherein in the step of with the guidance of the visible laser, setting the grating, the 4f lens group and the camera on the optical path in sequence, the step further comprises:
adjusting an attitude of the front lens and an attitude of the rear lens, so that the target laser is perpendicularly incident to the front lens and the rear lens and the target laser passes through the center of the front lens and the center of the rear lens based on a position deviation between the visible laser reflected by the 4f lens group and the first spatial location;
adjusting the camera based on a position deviation between the visible laser reflected by the camera and the anterior spatial location, so that the target laser is perpendicularly incident to the camera.

17. The building method of the optical path according to claim 14, wherein in the step of controlling the imaging sensor locate at the rear focal plane of the rear lens at the target waveband, the step further comprises:
setting the rear lens, and then setting the camera; next, setting the front lens;
when setting the camera, controlling the imaging sensor locate at the rear focal plane of the rear lens at the target waveband based on the spot that the imaging sensor sensed.

18. The building method of the optical path according to claim 17, wherein the first spatial location that the visible laser passed through is located in front the front lens, the second spatial location that the visible laser passed through is located behind the camera,
both the first spatial location and the second spatial location are located at a coaxial portion between the target laser and the visible laser, the first spatial location and the second spatial location are configured to adjust the attitude of the 4f lens group,
wherein after the step of controlling the imaging sensor locate behind the rear focal plane of the rear lens at the target waveband, the building method of the optical path further comprises:
removing the camera from the optical path, and then setting the front lens based on the first spatial location and the second spatial location, and adjusting the attitude of the front lens at least;
moving the camera back to the optical path after setting the front lens.

19. The building method of the optical path according to claim 13, wherein the visible laser passes through the first spatial location and the second spatial location,
wherein in the step of controlling the rear focal plane of the front lens coincide with the front focal plane of the rear lens, the step further comprises:
obtaining a first target distance between the front lens and the rear lens, and a second target distance between the front lens and the rear lens, and obtaining a difference of the distance between the first target distance and the second target distance,
wherein when a distance between the front lens and the rear lens keeps the first target distance, the rear focal plane of the front lens at the visible waveband coincides with the front focal plane of the rear lens at the visible waveband,
wherein when the front lens and the rear lens keep the second target distance, the rear focal plane of the front lens at the visible waveband coincides with the front focal plane of the rear lens at the visible waveband,
based on the spot size of the visible laser at the first spatial location and the spot size of the visible laser at the second spatial location, adjusting a distance between the front lens and the rear lens to the first target distance, and then based on the difference of the distance, adjusting the first target between the front lens and the rear lens to the second target distance.

20. A phase detection system, wherein the phase detection system comprises the wavefront detection system according to claim 1, a sample to be detected that is set between the target light source and the grating, and the target laser is incident to the sample to be detected, and the target laser passes through a center of the sample; a processor,
wherein the processor is electrically connected to the camera, and the processor is configured to receive an interference image that the target laser sensed by the imaging sensor, so as to detect a phase distribution of the sample based on the interference image.
